(19) United States
(12) Patent Application Publication
(10) Pub. No.: US 2026/0021913 A1
(43) Pub. Date: Jan. 22, 2026

(54) Methods and Systems for Deep Stall Control of Uncrewed Aerial Vehicles

(71) Applicant: Wing Aviation LLC, Palo Alto, CA (US)

(72) Inventors: André Peter Prager, Sunnyvale, CA (US); Martin Gomez, Palo Alto, CA (US); Bob Parks, Palo Alto, CA (US)

(21) Appl. No.: 18/779,045

(22) Filed: Jul. 21, 2024

(51) Int. Cl. B64U 40/20; B64U 10/20; B64U 30/40; B64U 70/40; B64U 101/64; G05D 1/495; G05D 1/654

(52) U.S. Cl. CPC B64U 40/20; B64U 10/20; B64U 30/40; B64U 70/40; G05D 1/6545; G05D 1/6546; B64U 2101/64; B64U 2201/104; G05D 1/495

(57) ABSTRACT

Examples relate to uncrewed aerial vehicles (UAVs) and methods for controlled descent during control tier failures. A computing device may initially detect a control tier failure at an UAV. In some examples, the UAV includes a fuselage, a pair of wings extending outwardly from the fuselage, and a pair of stabilizers arranged in a V-shape configuration. Each stabilizer has a control surface that is adjustable relative to a fixed portion of the stabilizer. Based on detecting the control tier failure at the UAV, the computing device may adjust the control surface of each stabilizer from a first angle to a second angle relative to the fixed portion of the stabilizer. By adjusting the angle between the control surfaces and fixed portions of one or both stabilizers, the UAV may induce a deep stall maneuver that can enable a controlled descent of the UAV.

### BACKGROUND

Uncrewed aerial vehicles (UAVs) have increased in popularity in recent years and are often used in a wide range of applications, from recreational flying and photography to commercial delivery services and rescue operations. One of the challenges in operating UAVs is ensuring safe operation, particularly in the event of a failure in the flight control system.

In some cases, a UAV may experience a control tier failure caused by a malfunction or breakdown in the systems responsible for the flight control of the UAV. This may include failures in the hardware or software components that manage the UAV's stability, navigation, and response to pilot commands. Such failures can result in the UAV's inability to maintain controlled flight, potentially leading to an uncontrolled descent or crash. Control tier failures can be caused by a variety of issues, such as sensor malfunctions, communication disruptions, power failures, or software glitches. In the event of a control tier failure during flight, it is imperative to have a reliable flight maneuver that can be implemented to reduce the velocity of the UAV and ensure a safe descent.

Traditional methods of reducing velocity and controlling descent in the event of a failure often involve the use of parachutes or other similar devices. However, these methods can add complexity, weight, and cost to the UAV design. Furthermore, parachutes and other devices may not be reliable in all situations, and their deployment may be affected by various factors, such as wind conditions and the altitude at which the failure occurs. Another approach to controlling the descent of a UAV in the event of a failure is to induce a stall. A stall occurs when the airflow over the wings of an aircraft is disrupted, causing a loss of lift. By carefully controlling the stall, it is possible to reduce the horizontal speed of the UAV, which can allow the UAV to descend slowly and safely. However, inducing and controlling a stall in a UAV presents its own set of challenges. For instance, there is a risk of losing control of the UAV during the stall, which could result in an uncontrolled descent and crash.

Therefore, there is a need for improved methods and systems for controlling the descent of UAVs in the event of a flight control system failure. Such methods and systems would ideally be reliable, easy to implement, and not add excessive weight or complexity to the UAV design.

### SUMMARY

Example embodiments relate to methods and systems for deep stall control of uncrewed aerial vehicles (UAVs). Disclosed solutions may involve adjusting the angle of a control surface on one or multiple stabilizers positioned at the tail of an UAV to induce a deep stall in response to detecting a control tier failure at the UAV. In some cases, the control surfaces are located on distributed stabilizers that form a V-shape tail of the UAV.

In a first example embodiment, a method for controlling a descent of an uncrewed aerial vehicle (UAV) during a control tier failure is described. The method involves detecting, by a computing device, the control tier failure at UAV. The UAV includes a fuselage, a pair of wings extending outwardly from the fuselage, and a pair of stabilizers arranged in a V-shape configuration. Each stabilizer has a control surface that is adjustable relative to a fixed portion of the stabilizer. The method also involves adjusting the control surface of each stabilizer from a first angle to a second angle relative to the fixed portion of the stabilizer based on detecting the control tier failure at the UAV.

In a second example embodiment, an uncrewed aerial vehicle (UAV) is described. The UAV includes a fuselage, a pair of wings extending outwardly from the fuselage, and a pair of stabilizers arranged in a V-shape configuration. Each stabilizer has a control surface that is adjustable relative to a fixed portion of the stabilizer. The UAV also includes a computing device, which is configured to perform operations in accordance with the first example embodiment.

In a third example embodiment, a non-transitory computer-readable medium may have stored thereon instructions that, when executed by a computing device, cause the computing device to perform operations in accordance with the first example embodiment.

In a fourth example embodiment, a system may include a processor configured to perform operations in accordance with the first example embodiment.

In a fifth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates an uncrewed aerial vehicle, in accordance with examples described herein.

FIG. 2 illustrates components of an uncrewed aerial system, in accordance with examples described herein.

FIG. 3 is a block diagram illustrating a distributed UAV system, in accordance with examples described herein.

FIG. 4 is a block diagram illustrating a system for implementing deep stall control of a UAV, in accordance with examples described herein.

FIG. 5A illustrates an UAV with its stabilizers arranged to perform a deep stall maneuver, in accordance with examples described herein.

FIG. 5B illustrates another view of a stabilizer of the UAV arranged to perform the deep stall maneuver, in accordance with examples described herein.

FIG. 5C illustrates another view of the other stabilizer of the UAV arranged to perform the deep stall maneuver, in accordance with examples described herein.

FIG. 6 is a flow chart of a method for implementing deep stall control of a UAV, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

The present disclosure relates to uncrewed aerial vehicles (UAVs) and methods for controlled descent during control tier failures. In some aspects, a UAV may include a fuselage, wings extending from the fuselage, and a pair of stabilizers arranged in a V-shape configuration. Each stabilizer may have a control surface and a fixed portion, with the control surface being adjustable relative to the fixed portion. The control surfaces may be manipulated to alter the flight characteristics of the UAV. In some cases, each stabilizer may extend in a vertical, diagonal direction relative to a longitudinal axis that extends through a length of the fuselage. In such a configuration, the pair of stabilizers may form a V-tail for the UAV.

By adjusting the angle between the control surfaces and fixed portions of one or both stabilizers, the UAV may induce a deep stall maneuver that can enable a controlled descent of the UAV. For example, the UAV may adjust the control surfaces from being substantially flat relative to the fixed portions of the stabilizers to an angle that positions the control surfaces substantially perpendicular to the fixed portions, which adjusts how air flows around the stabilizers. A computing device located onboard the UAV may detect a control tier failure and adjust the control surfaces of multiple stabilizers from a first angle to a second angle in response, such as from zero degrees to 90 degrees relative to the fixed portion of the stabilizer. In some cases, the computing device may determine the second angle to use when adjusting the control surfaces based on various factors, such as the UAV's current speed, altitude, weight, and environmental conditions (e.g., weather conditions and wind speed).

In general, a control surface of a stabilizer may be adjustable across a range of angles relative to the fixed portion of the stabilizer. During operation, the angle between the control surface and the fixed portion of each stabilizer can depend on the desired operation by the UAV. For instance, during normal forward travel, the control surfaces may be aligned substantially flat along the fixed portions of the stabilizers to limit disruption to air flow. Upon detection of a control tier failure, the control surfaces may be adjusted to a substantially perpendicular position relative to the fixed portions to cause the UAV to perform a deep stall maneuver.

In some aspects, the degree to which the control surface of a stabilizer is deflected may be varied to achieve different stall characteristics. For instance, while a deflection of 90 degrees may be used in some cases to induce a deep stall, other angles of deflection may be used in other cases. A smaller deflection angle, for instance, might result in a slower descent, while a larger deflection angle could cause a faster descent. In some cases, the control surface may be deflected to an angle less than 90 degrees. For example, a deflection angle of 60 degrees or 45 degrees may be used. This may result in a less severe stall, but still provide sufficient control authority for the UAV to manage a control tier failure. In other cases, the control surface may be deflected to an angle greater than 90 degrees. For example, a deflection angle of 120 degrees or 135 degrees may be used. This may induce a deeper stall, potentially allowing the UAV to descend more quickly.

These variations in the degree of control surface deflection provide a range of options for managing control tier failures, which may offer enhanced safety and reliability in UAV operations. By adjusting the degree of control surface deflection, the UAV can be tailored to achieve the desired stall characteristics, thereby optimizing the deep stall maneuver for different operational scenarios or requirements.

In some examples, a UAV may also include other structural components, such as one or multiple booms with each boom coupled to one of the wings and extending in parallel relative to the fuselage. The stabilizers may be coupled to ends of these booms positioned near the rear of the fuselage. With such a configuration, the stabilizers may be physically separate from each other and form a disconnected V-tail for the UAV. The gap of the V-tail configuration can depend on the space between the booms of the UAV. In addition, in some cases, hover rotors may be coupled to the booms. The hover rotors may be triggered to freely rotate during the deep stall maneuver, potentially providing additional drag to further slow the UAV's descent.

Disclosed solutions that enable controlled descent during control tier failures may provide advantages in various situations. For example, the deep stall maneuver may allow for a slower, more controlled descent compared to other failure modes, potentially reducing impact forces if the UAV were to reach the ground. The ability to adjust the control surface angles and use windmilling hover rotors may provide flexibility in managing the descent characteristics based on specific conditions.

In some cases, an example UAV may be equipped with different types of propellers to support the deep stall maneuver. The propellers may be designed with specific aerodynamic properties to optimize their performance during the deep stall maneuver. For instance, the propellers may be designed to generate increased drag when windmilling, thereby further reducing the UAV's descent velocity during the deep stall maneuver. In some cases, the UAV may also be configured to allow its hover rotors to freely windmill during descent, further reducing the descent velocity by increasing drag.

In other aspects, the UAV may also include additional control surfaces to enhance the deep stall maneuver. These additional control surfaces may be strategically positioned on the UAV to provide additional control authority during the deep stall maneuver. For example, the UAV may include additional ailerons or flaps that can be deflected to increase drag or alter the UAV's attitude during the deep stall maneuver. In some embodiments, the UAV may be designed with a combination of these variations. For instance, the UAV may feature a larger tail, specific propeller designs, and additional control surfaces, which may all work in concert to optimize the deep stall maneuver. These variations in the configuration of the UAV may provide a range of options for managing control tier failures, offering enhanced safety and reliability in UAV operations.

In some aspects, the UAV may be designed to carry a payload, which can vary based on the intended application of the UAV. As such, the UAV may include mechanisms for securing and potentially deploying the payload. Similarly, communication systems may also be incorporated into the UAV to allow for remote control, telemetry transmission, and data exchange with ground stations, remote devices, and/or other aircraft. In general, the purpose of the UAV may vary depending on its specific configuration and intended use. For instance, a UAV may be designed for package delivery, aerial surveying, search and rescue operations, or other specialized tasks. The UAV system's components and capabilities may be tailored to suit these various purposes.

In some implementations, a UAV system may include one or more propulsion systems, which may include hover rotors for vertical takeoff and landing capabilities, as well as a cruise propeller for forward flight. The propulsion systems may be powered by batteries or other energy sources. An onboard computing device may control various functions of the UAV, including flight control, navigation, and system monitoring. In some cases, the computing device may be capable of detecting failures and implementing contingency procedures. The computing device may use sensors that provide data on the UAV's position, orientation, speed, and environmental conditions for flight control and decision-making.

In some aspects, a method of detecting a stall and activating the stall maneuver may be varied. For instance, different sensors may be used to detect a stall. These sensors may include, but are not limited to, airspeed sensors, angle of attack sensors, or inertial measurement units. The sensors may provide data that can be processed to determine whether the UAV is in a stall condition. In some cases, the data from these sensors may be compared to predetermined thresholds to determine whether a stall has occurred. In some embodiments, algorithms may be used to detect a stall. These algorithms may analyze data from one or more sensors to determine whether the UAV is in a stall condition. The algorithms may use various techniques, such as machine learning algorithms, statistical analysis, or other data processing techniques, to analyze the sensor data and detect a stall. The activation of the stall maneuver may also be varied. In some cases, the stall maneuver may be activated manually by a pilot. For instance, the pilot may activate the stall maneuver by inputting a command through a remote control or a control interface on the UAV. In other cases, the stall maneuver may be activated automatically by the flight controller. For example, the flight controller may activate the stall maneuver when it detects a stall condition based on data from the sensors or the algorithms. These variations in the method of detecting a stall and activating the stall maneuver provide a range of options for managing control tier failures, offering enhanced safety and reliability in UAV operations. By adjusting the method of detecting a stall and activating the stall maneuver, the UAV can be tailored to respond effectively to different operational scenarios or requirements.

In some examples, disclosed techniques for reducing the velocity of a UAV during an uncontrolled descent may involve the use of an oversized stabilizer on the UAV's V-Tail. The oversized stabilizer can be deflected so that the trailing edge is angled upwards at extreme angles, inducing a deep stall that reduces horizontal speed and helps the UAV achieve a stable, reduced sink rate. The UAV transitions into the high drag configuration to position the UAV in a safer descent than if the UAV failed to enter into the deep stall and descended in a nose-down configuration. The loss of elevator authority typically associated with deep stalls is prevented by the oversized stabilizer. The UAV's hover rotors can also freely windmill during the descent, increasing drag and further reducing descent velocity. The method is particularly useful in scenarios of control tier failure in flight, allowing for a safer and more controlled descent. The method can be implemented with various aircraft configurations and entry conditions into the uncontrolled descent.

Herein, the terms “unmanned aerial system,” “uncrewed aerial system,” and/or “UAV” refer to any autonomous or semi-autonomous vehicle that is capable of performing some functions without a physically present human pilot. A UAV can take various forms. For example, a UAV may take the form of a fixed-wing aircraft, a glider aircraft, a tail-sitter aircraft, a jet aircraft, a ducted fan aircraft, a lighter-than-air dirigible such as a blimp or steerable balloon, a rotorcraft such as a helicopter or multicopter, and/or an ornithopter, among other possibilities. Further, the terms “drone,” “uncrewed aerial vehicle system” (UAVS), “unmanned aerial vehicle,” or “uncrewed aerial vehicle” may also be used to refer to a UAV.

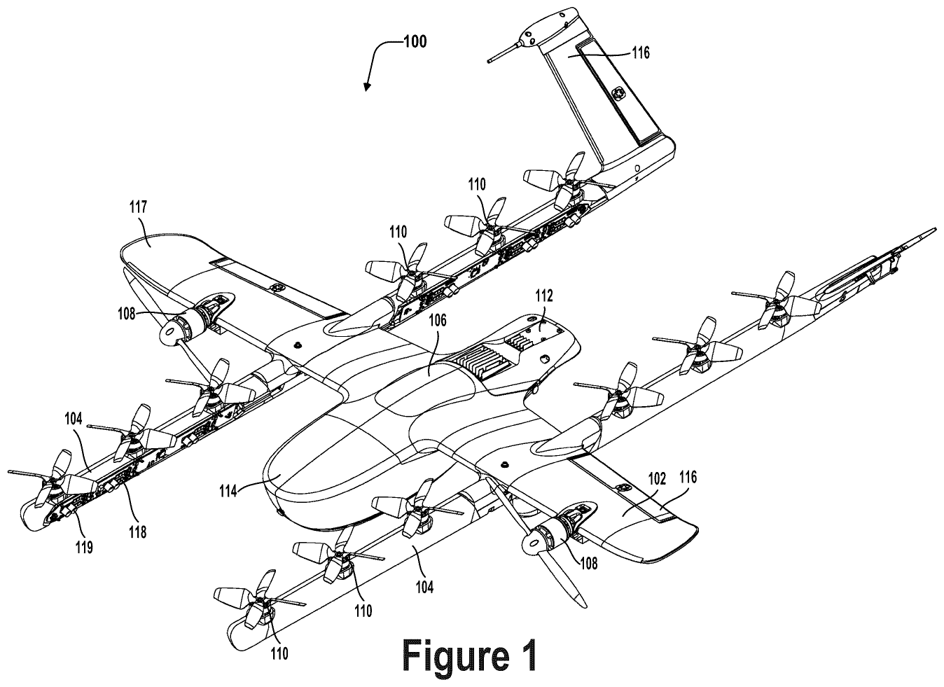

FIG. 1 is an isometric view of an example UAV 100. UAV 100 includes wing 102, booms 104, and a fuselage 106. Wings 102 may be stationary and may generate lift based on the wing shape and the UAV's forward airspeed. For instance, the two wings 102 may have an airfoil-shaped cross section to produce an aerodynamic force on UAV 100. In some embodiments, wing 102 may carry horizontal propulsion units 108, and booms 104 may carry vertical propulsion units 110. In operation, power for the propulsion units may be provided from a battery compartment 112 of fuselage 106. In some embodiments, fuselage 106 also includes an avionics compartment 114, an additional battery compartment (not shown) and/or a delivery unit (not shown, e.g., a winch system) for handling the payload. In some embodiments, fuselage 106 is modular, and two or more compartments (e.g., battery compartment 112, avionics compartment 114, other payload and delivery compartments) are detachable from each other and securable to each other (e.g., mechanically, magnetically, or otherwise) to contiguously form at least a portion of fuselage 106.

In some embodiments, booms 104 terminate in rudders 116 for improved yaw control of UAV 100. Further, wings 102 may terminate in wing tips 117 for improved control of lift of the UAV.

In the illustrated configuration, UAV 100 includes a structural frame. The structural frame may be referred to as a “structural H-frame” or an “H-frame” (not shown) of the UAV. The H-frame may include, within wings 102, a wing spar (not shown) and, within booms 104, boom carriers (not shown). In some embodiments the wing spar and the boom carriers may be made of carbon fiber, hard plastic, aluminum, light metal alloys, or other materials. The wing spar and the boom carriers may be connected with clamps. The wing spar may include pre-drilled holes for horizontal propulsion units 108, and the boom carriers may include pre-drilled holes for vertical propulsion units 110.

In some embodiments, fuselage 106 may be removably attached to the H-frame (e.g., attached to the wing spar by clamps, configured with grooves, protrusions or other features to mate with corresponding H-frame features, etc.). In other embodiments, fuselage 106 similarly may be removably attached to wings 102. The removable attachment of fuselage 106 may improve quality and or modularity of UAV 100. For example, electrical/mechanical components and/or subsystems of fuselage 106 may be tested separately from, and before being attached to, the H-frame. Similarly, printed circuit boards (PCBs) 118 may be tested separately from, and before being attached to, the boom carriers, therefore eliminating defective parts/subassemblies prior to completing the UAV. For example, components of fuselage 106 (e.g., avionics, battery unit, delivery units, an additional battery compartment, etc.) may be electrically tested before fuselage 106 is mounted to the H-frame. Furthermore, the motors and the electronics of PCBs 118 may also be electrically tested before the final assembly. Generally, the identification of the defective parts and subassemblies early in the assembly process lowers the overall cost and lead time of the UAV. Furthermore, different types/models of fuselage 106 may be attached to the H-frame, therefore improving the modularity of the design. Such modularity allows these various parts of UAV 100 to be upgraded without a substantial overhaul to the manufacturing process.

In some embodiments, a wing shell and boom shells may be attached to the H-frame by adhesive elements (e.g., adhesive tape, double-sided adhesive tape, glue, etc.). Therefore, multiple shells may be attached to the H-frame instead of having a monolithic body sprayed onto the H-frame. In some embodiments, the presence of the multiple shells reduces the stresses induced by the coefficient of thermal expansion of the structural frame of the UAV. As a result, the UAV may have better dimensional accuracy and/or improved reliability.

Moreover, in at least some embodiments, the same H-frame may be used with the wing shell and/or boom shells having different size and/or design, therefore improving the modularity and versatility of the UAV designs. The wing shell and/or the boom shells may be made of relatively light polymers (e.g., closed cell foam) covered by the harder, but relatively thin, plastic skins.

The power and/or control signals from fuselage 106 may be routed to PCBs 118 through cables running through fuselage 106, wings 102, and booms 104. In the illustrated embodiment, UAV 100 has four PCBs, but other numbers of PCBs are also possible. For example, UAV 100 may include two PCBs, one per the boom. The PCBs carry electronic components 119 including, for example, power converters, controllers, memory, passive components, etc. In operation, propulsion units 108 and 110 of UAV 100 are electrically connected to the PCBs.

Many variations on the illustrated UAV are possible. For instance, fixed-wing UAVs may include more or fewer rotor units (vertical or horizontal), and/or may utilize a ducted fan or multiple ducted fans for propulsion. Further, example UAVs with more wings (e.g., an “x-wing” configuration with four wings) are also possible. Although FIG. 1 illustrates two wings 102, two booms 104, two horizontal propulsion units 108, and six vertical propulsion units 110 per boom 104, it should be appreciated that other variants of UAV 100 may be implemented with more or less of these components. For example, UAV 100 may include four wings 102, four booms 104, and more or less propulsion units (horizontal or vertical).

Many variations on fixed-wing UAVs are possible. For instance, fixed-wing UAVs may include more or fewer propellers, and/or may utilize a ducted fan or multiple ducted fans for propulsion. Further, UAVs with more wings (e.g., an “x-wing” configuration with four wings), with fewer wings, or even with no wings, are also possible.

It should be understood that references herein to an “uncrewed” aerial vehicle or UAV can apply equally to autonomous and semi-autonomous aerial vehicles. In an autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

More generally, it should be understood that the example UAVs described herein are not intended to be limiting. Example embodiments may relate to, be implemented within, or take the form of any type of uncrewed aerial vehicle.

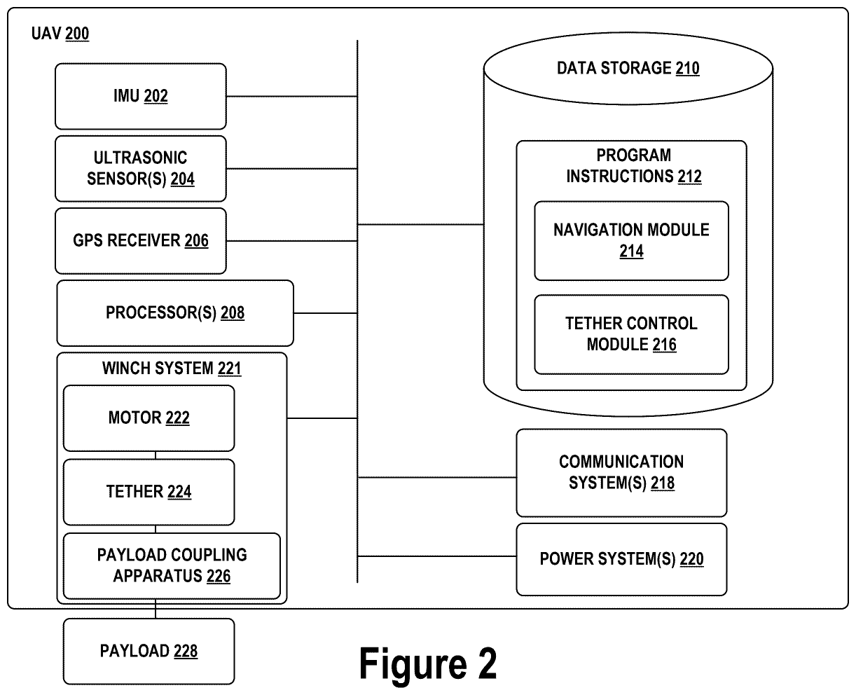

FIG. 2 is a simplified block diagram illustrating components of UAV 200, according to an example embodiment. UAV 200 may take the form of, or be similar in form to UAV 100 described in reference to FIG. 1. However, UAV 200 may also take other forms.

UAV 200 may include various types of sensors, and may include a computing system configured to provide the functionality described herein. In the illustrated embodiment, the sensors of UAV 200 include inertial measurement unit (IMU) 202, ultrasonic sensor(s) 204, and GPS receiver 206, among other possible sensors and sensing systems.

In the illustrated embodiment, UAV 200 also includes processor(s) 208. Processor 208 may be a general-purpose processor or a special purpose processor (e.g., digital signal processors, application specific integrated circuits, etc.). Processor(s) 208 can be configured to execute computer-readable program instructions 212 that are stored in data storage 210 and are executable to provide the functionality of a UAV described herein.

Data storage 210 may include or take the form of one or more computer-readable storage media that can be read or accessed by at least one processor 208. The one or more computer-readable storage media can include volatile and/or non-volatile storage components, such as optical, magnetic, organic or other memory or disc storage, which can be integrated in whole or in part with at least one of processor(s) 208. In some embodiments, data storage 210 can be implemented using a single physical device (e.g., one optical, magnetic, organic or other memory or disc storage unit), while in other embodiments, data storage 210 can be implemented using two or more physical devices.

As noted, data storage 210 can include computer-readable program instructions 212 and perhaps additional data, such as diagnostic data of UAV 200. As such, data storage 210 may include program instructions 212 to perform or facilitate some or all of the UAV functionality described herein. For instance, in the illustrated embodiment, program instructions 212 include navigation module 214 and tether control module 216.

In an illustrative embodiment, IMU 202 may include both an accelerometer and a gyroscope, which may be used together to determine an orientation of UAV 200. In particular, the accelerometer can measure the orientation of the vehicle with respect to earth, while the gyroscope measures the rate of rotation around an axis. IMUs are commercially available in low-cost, low-power packages. For instance, IMU 202 may take the form of or include a miniaturized MicroElectroMechanical System (MEMS) or a NanoElectroMechanical System (NEMS). Other types of IMUs may also be utilized.

IMU 202 may include other sensors, in addition to accelerometers and gyroscopes, which may help to better determine position and/or help to increase autonomy of UAV 200. Two examples of such sensors are magnetometers and pressure sensors. In some embodiments, a UAV may include a low-power, digital 3-axis magnetometer, which can be used to realize an orientation independent electronic compass for accurate heading information. However, other types of magnetometers may be utilized as well. Other examples are also possible. Further, note that a UAV could include some or all of the above-described inertia sensors as separate components from an IMU.

UAV 200 may also include a pressure sensor or barometer, which can be used to determine the altitude of UAV 200. Alternatively, other sensors, such as sonic altimeters or radar altimeters, can be used to provide an indication of altitude, which may help to improve the accuracy of and/or prevent drift of an IMU.

In a further aspect, UAV 200 may include one or more sensors that allow the UAV to sense objects in the environment. For instance, in the illustrated embodiment, UAV 200 includes ultrasonic sensor(s) 204. Ultrasonic sensor(s) 204 can determine the distance to an object by generating sound waves and determining the time interval between transmitting the wave and receiving the corresponding echo off an object. A typical application of an ultrasonic sensor for uncrewed vehicles or IMUs is low-level altitude control and obstacle avoidance. An ultrasonic sensor can also be used for vehicles that need to hover at a certain height or need to be capable of detecting obstacles. Other systems can be used to determine, sense the presence of, and/or determine the distance to nearby objects, such as a light detection and ranging (LIDAR) system, laser detection and ranging (LADAR) system, and/or an infrared or forward-looking infrared (FLIR) system, among other possibilities.

In some embodiments, UAV 200 may also include one or more imaging system(s). For example, one or more still and/or video cameras may be utilized by UAV 200 to capture image data from the UAV's environment. As a specific example, charge-coupled device (CCD) cameras or complementary metal-oxide-semiconductor (CMOS) cameras can be used with uncrewed vehicles. Such imaging sensor(s) have numerous possible applications, such as obstacle avoidance, localization techniques, ground tracking for more accurate navigation (e,g, by applying optical flow techniques to images), video feedback, and/or image recognition and processing, among other possibilities.

UAV 200 may also include GPS receiver 206. GPS receiver 206 may be configured to provide data that is typical of well-known GPS systems, such as the GPS coordinates of UAV 200.

Such GPS data may be utilized by UAV 200 for various functions. As such, the UAV may use GPS receiver 206 to help navigate to the caller's location, as indicated, at least in part, by the GPS coordinates provided by their mobile device. Other examples are also possible.

Navigation module 214 may provide functionality that allows UAV 200 to, for example, move about its environment and reach a desired location. To do so, navigation module 214 may control the altitude and/or direction of flight by controlling the mechanical features of the UAV that affect flight (e.g., its rudder(s), elevator(s), aileron(s), and/or the speed of its propeller(s)).

In order to navigate UAV 200 to a target location, navigation module 214 may implement various navigation techniques, such as map-based navigation and localization-based navigation, for instance. With map-based navigation, UAV 200 may be provided with a map of its environment, which may then be used to navigate to a particular location on the map. With localization-based navigation, UAV 200 may be capable of navigating in an unknown environment using localization. Localization-based navigation may involve UAV 200 building its own map of its environment and calculating its position within the map and/or the position of objects in the environment. For example, as UAV 200 moves throughout its environment, UAV 200 may continuously use localization to update its map of the environment. This continuous mapping process may be referred to as simultaneous localization and mapping (SLAM). Other navigation techniques may also be utilized.

In some embodiments, navigation module 214 may navigate using a technique that relies on waypoints. In particular, waypoints are sets of coordinates that identify points in physical space. For instance, an air-navigation waypoint may be defined by a certain latitude, longitude, and altitude. Accordingly, navigation module 214 may cause UAV 200 to move from waypoint to waypoint, in order to ultimately travel to a final destination (e.g., a final waypoint in a sequence of waypoints).

In a further aspect, navigation module 214 and/or other components and systems of UAV 200 may be configured for “localization” to more precisely navigate to the scene of a target location. More specifically, it may be desirable in certain situations for a UAV to be within a threshold distance of the target location where payload 228 is being delivered by a UAV (e.g., within a few feet of the target destination). To this end, a UAV may use a two-tiered approach in which it uses a more-general location-determination technique to navigate to a general area that is associated with the target location, and then use a more-refined location-determination technique to identify and/or navigate to the target location within the general area.

For example, UAV 200 may navigate to the general area of a target destination where payload 228 is being delivered using waypoints and/or map-based navigation. The UAV may then switch to a mode in which it utilizes a localization process to locate and travel to a more specific location. For instance, if UAV 200 is to deliver a payload to a user's home, UAV 200 may need to be substantially close to the target location in order to avoid delivery of the payload to undesired areas (e.g., onto a roof, into a pool, onto a neighbor's property, etc.). However, a GPS signal may only get UAV 200 so far (e.g., within a block of the user's home). A more precise location-determination technique may then be used to find the specific target location.

Various types of location-determination techniques may be used to accomplish localization of the target delivery location once UAV 200 has navigated to the general area of the target delivery location. For instance, UAV 200 may be equipped with one or more sensory systems, such as, for example, ultrasonic sensors 204, infrared sensors (not shown), and/or other sensors, which may provide input that navigation module 214 utilizes to navigate autonomously or semi-autonomously to the specific target location.

As another example, once UAV 200 reaches the general area of the target delivery location (or of a moving subject such as a person or their mobile device), UAV 200 may switch to a “fly-by-wire” mode where it is controlled, at least in part, by a remote operator, who can navigate UAV 200 to the specific target location. To this end, sensory data from UAV 200 may be sent to the remote operator to assist them in navigating UAV 200 to the specific location.

As yet another example, UAV 200 may include a module that is able to signal to a passer-by for assistance in reaching the specific target delivery location. For example, the UAV 200 may display a visual message requesting such assistance in a graphic display or play an audio message or tone through speakers to indicate the need for such assistance, among other possibilities. Such a visual or audio message might indicate that assistance is needed in delivering UAV 200 to a particular person or a particular location, and might provide information to assist the passer-by in delivering UAV 200 to the person or location (e.g., a description or picture of the person or location, and/or the person or location's name), among other possibilities. Such a feature can be useful in a scenario in which the UAV is unable to use sensory functions or another location-determination technique to reach the specific target location. However, this feature is not limited to such scenarios.

In some embodiments, once UAV 200 arrives at the general area of a target delivery location, UAV 200 may utilize a beacon from a user's remote device (e.g., the user's mobile phone) to locate the person. Such a beacon may take various forms. As an example, consider the scenario where a remote device, such as the mobile phone of a person who requested a UAV delivery, is able to send out directional signals (e.g., via an RF signal, a light signal and/or an audio signal). In this scenario, UAV 200 may be configured to navigate by “sourcing” such directional signals—in other words, by determining where the signal is strongest and navigating accordingly. As another example, a mobile device can emit a frequency, either in the human range or outside the human range, and UAV 200 can listen for that frequency and navigate accordingly. As a related example, if UAV 200 is listening for spoken commands, then UAV 200 could utilize spoken statements, such as “I'm over here!” to source the specific location of the person requesting delivery of a payload.

In an alternative arrangement, a navigation module may be implemented at a remote computing device, which communicates wirelessly with UAV 200. The remote computing device may receive data indicating the operational state of UAV 200, sensor data from UAV 200 that allows it to assess the environmental conditions being experienced by UAV 200, and/or location information for UAV 200. Provided with such information, the remote computing device may determine altitudinal and/or directional adjustments that should be made by UAV 200 and/or may determine how UAV 200 should adjust its mechanical features (e.g., its rudder(s), elevator(s), aileron(s), and/or the speed of its propeller(s)) in order to effectuate such movements. The remote computing system may then communicate such adjustments to UAV 200 so it can move in the determined manner.

In a further aspect, UAV 200 includes one or more communication system(s) 218.

Communications system(s) 218 may include one or more wireless interfaces and/or one or more wireline interfaces, which allow UAV 200 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network.

In some embodiments, UAV 200 may include communication systems 218 that allow for both short-range communication and long-range communication. For example, UAV 200 may be configured for short-range communications using Bluetooth and for long-range communications under a CDMA protocol. In such an embodiment, UAV 200 may be configured to function as a “hot spot;” or in other words, as a gateway or proxy between a remote support device and one or more data networks, such as a cellular network and/or the Internet. Configured as such, UAV 200 may facilitate data communications that the remote support device would otherwise be unable to perform by itself.

For example, UAV 200 may provide a WiFi connection to a remote device, and serve as a proxy or gateway to a cellular service provider's data network, which the UAV might connect to under an LTE or a 3G protocol, for instance. UAV 200 could also serve as a proxy or gateway to a high-altitude balloon network, a satellite network, or a combination of these networks, among others, which a remote device might not be able to otherwise access.

In a further aspect, UAV 200 may include power system(s) 220. Power system(s) 220 may include one or more batteries for providing power to UAV 200. In one example, the one or more batteries may be rechargeable and each battery may be recharged via a wired connection between the battery and a power supply and/or via a wireless charging system, such as an inductive charging system that applies an external time-varying magnetic field to an internal battery.

UAV 200 may use various systems and configurations in order to transport and deliver payload 228. In some implementations, payload 228 of UAV 200 may include or take the form of a “package” designed to transport various goods to a target delivery location. For example, UAV 200 can include a compartment, in which an item or items may be transported. Such a package may one or more food items, purchased goods, medical items, or any other object(s) having a size and weight suitable to be transported between two locations by the UAV. In other embodiments, payload 228 may simply be the one or more items that are being delivered (e.g., without any package housing the items).

In some embodiments, payload 228 may be attached to the UAV and located substantially outside of the UAV during some or all of a flight by the UAV. For example, the package may be tethered or otherwise releasably attached below the UAV during flight to a target location. In an embodiment where a package carries goods below the UAV, the package may include various features that protect its contents from the environment, reduce aerodynamic drag on the system, and prevent the contents of the package from shifting during UAV flight.

In order to deliver the payload, the UAV may include winch system 221 controlled by tether control module 216 in order to lower payload 228 to the ground while UAV 200 hovers above. As shown in FIG. 2, winch system 221 may include tether 224, and tether 224 may be coupled to payload 228 by payload coupling apparatus 226. Tether 224 may be wound on a spool that is coupled to motor 222 of the UAV. Motor 222 may take the form of a DC motor (e.g., a servo motor) that can be actively controlled by a speed controller. Tether control module 216 can control the speed controller to cause motor 222 to rotate the spool, thereby unwinding or retracting tether 224 and lowering or raising payload coupling apparatus 226. In practice, the speed controller may output a desired operating rate (e.g., a desired RPM) for the spool, which may correspond to the speed at which tether 224 and payload 228 should be lowered towards the ground. Motor 222 may then rotate the spool so that it maintains the desired operating rate.

In order to control motor 222 via the speed controller, tether control module 216 may receive data from a speed sensor (e.g., an encoder) configured to convert a mechanical position to a representative analog or digital signal. In particular, the speed sensor may include a rotary encoder that may provide information related to rotary position (and/or rotary movement) of a shaft of the motor or the spool coupled to the motor, among other possibilities. Moreover, the speed sensor may take the form of an absolute encoder and/or an incremental encoder, among others. So in an example implementation, as motor 222 causes rotation of the spool, a rotary encoder may be used to measure this rotation. In doing so, the rotary encoder may be used to convert a rotary position to an analog or digital electronic signal used by tether control module 216 to determine the amount of rotation of the spool from a fixed reference angle and/or to an analog or digital electronic signal that is representative of a new rotary position, among other options. Other examples are also possible.

Based on the data from the speed sensor, tether control module 216 may determine a rotational speed of motor 222 and/or the spool and responsively control motor 222 (e.g., by increasing or decreasing an electrical current supplied to motor 222) to cause the rotational speed of motor 222 to match a desired speed. When adjusting the motor current, the magnitude of the current adjustment may be based on a proportional-integral-derivative (PID) calculation using the determined and desired speeds of motor 222. For instance, the magnitude of the current adjustment may be based on a present difference, a past difference (based on accumulated error over time), and a future difference (based on current rates of change) between the determined and desired speeds of the spool.

In some embodiments, tether control module 216 may vary the rate at which tether 224 and payload 228 are lowered to the ground. For example, the speed controller may change the desired operating rate according to a variable deployment-rate profile and/or in response to other factors in order to change the rate at which payload 228 descends toward the ground. To do so, tether control module 216 may adjust an amount of braking or an amount of friction that is applied to tether 224. For example, to vary the tether deployment rate, UAV 200 may include friction pads that can apply a variable amount of pressure to tether 224. As another example, UAV 200 can include a motorized braking system that varies the rate at which the spool lets out tether 224. Such a braking system may take the form of an electromechanical system in which motor 222 operates to slow the rate at which the spool lets out tether 224. Further, motor 222 may vary the amount by which it adjusts the speed (e.g., the RPM) of the spool, and thus may vary the deployment rate of tether 224. Other examples are also possible.

In some embodiments, tether control module 216 may be configured to limit the motor current supplied to motor 222 to a maximum value. With such a limit placed on the motor current, there may be situations where motor 222 cannot operate at the desired rate specified by the speed controller. For instance, there may be situations where the speed controller specifies a desired operating rate at which motor 222 should retract tether 224 toward UAV 200, but the motor current may be limited such that a large enough downward force on tether 224 would counteract the retracting force of motor 222 and cause tether 224 to unwind instead. A limit on the motor current may be imposed and/or altered depending on an operational state of UAV 200.

In some embodiments, tether control module 216 may be configured to determine a status of tether 224 and/or payload 228 based on the amount of current supplied to motor 222. For instance, if a downward force is applied to tether 224 (e.g., if payload 228 is attached to tether 224 or if tether 224 gets snagged on an object when retracting toward UAV 200), tether control module 216 may need to increase the motor current in order to cause the determined rotational speed of motor 222 and/or spool to match the desired speed. Similarly, when the downward force is removed from tether 224 (e.g., upon delivery of payload 228 or removal of a tether snag), tether control module 216 may need to decrease the motor current in order to cause the determined rotational speed of motor 222 and/or spool to match the desired speed. As such, tether control module 216 may be configured to monitor the current supplied to motor 222. For instance, tether control module 216 could determine the motor current based on sensor data received from a current sensor of the motor or a current sensor of power system 220. In any case, based on the current supplied to motor 222, tether control module 216 may determine if payload 228 is attached to tether 224, if someone or something is pulling on tether 224, and/or if payload coupling apparatus 226 is pressing against UAV 200 after retracting tether 224. Other examples are possible as well.

During delivery of payload 228, payload coupling apparatus 226 can be configured to secure payload 228 while being lowered from the UAV by tether 224, and can be further configured to release payload 228 upon reaching ground level. Payload coupling apparatus 226 can then be retracted to the UAV by reeling in tether 224 using motor 222.

In some implementations, payload 228 may be passively released once it is lowered to the ground. For example, a passive release mechanism may include one or more swing arms adapted to retract into and extend from a housing. An extended swing arm may form a hook on which payload 228 may be attached. Upon lowering the release mechanism and payload 228 to the ground via a tether, a gravitational force as well as a downward inertial force on the release mechanism may cause payload 228 to detach from the hook allowing the release mechanism to be raised upwards toward the UAV. The release mechanism may further include a spring mechanism that biases the swing arm to retract into the housing when there are no other external forces on the swing arm. For instance, a spring may exert a force on the swing arm that pushes or pulls the swing arm toward the housing such that the swing arm retracts into the housing once the weight of payload 228 no longer forces the swing arm to extend from the housing. Retracting the swing arm into the housing may reduce the likelihood of the release mechanism snagging payload 228 or other nearby objects when raising the release mechanism toward the UAV upon delivery of payload 228.

Active payload release mechanisms are also possible. For example, sensors such as a barometric pressure based altimeter and/or accelerometers may help to detect the position of the release mechanism (and the payload) relative to the ground. Data from the sensors can be communicated back to the UAV and/or a control system over a wireless link and used to help in determining when the release mechanism has reached ground level (e.g., by detecting a measurement with the accelerometer that is characteristic of ground impact). In other examples, the UAV may determine that the payload has reached the ground based on a weight sensor detecting a threshold low downward force on the tether and/or based on a threshold low measurement of power drawn by the winch when lowering the payload.

Other systems and techniques for delivering a payload, in addition or in the alternative to a tethered delivery system are also possible. For example, UAV 200 could include an air-bag drop system or a parachute drop system. Alternatively, UAV 200 carrying a payload could simply land on the ground at a delivery location. Other examples are also possible.

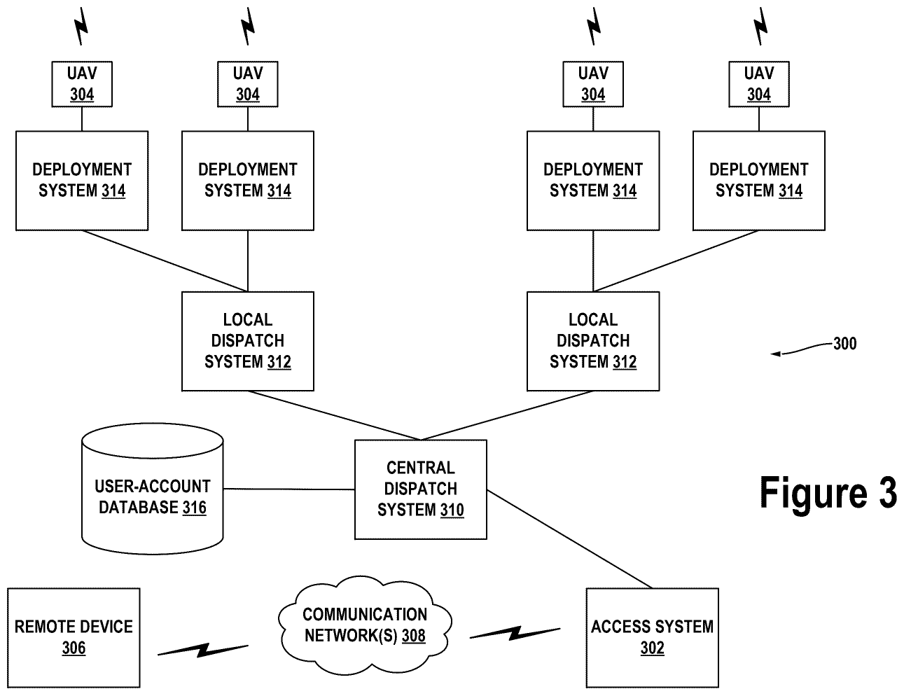

UAV systems may be implemented in order to provide various UAV-related services. In particular, UAVs may be provided at a number of different launch sites that may be in communication with regional and/or central control systems. Such a distributed UAV system may allow UAVs to be quickly deployed to provide services across a large geographic area (e.g., that is much larger than the flight range of any single UAV). For example, UAVs capable of carrying payloads may be distributed at a number of launch sites across a large geographic area (possibly even throughout an entire country, or even worldwide), in order to provide on-demand transport of various items to locations throughout the geographic area. FIG. 3 is a simplified block diagram illustrating a distributed UAV system 300, according to an example embodiment.

In the illustrative UAV system 300, access system 302 may allow for interaction with, control of, and/or utilization of a network of UAVs 304. In some embodiments, access system 302 may be a computing system that allows for human-controlled dispatch of UAVs 304. As such, the control system may include or otherwise provide a user interface through which a user can access and/or control UAVs 304.

In some embodiments, dispatch of UAVs 304 may additionally or alternatively be accomplished via one or more automated processes. For instance, access system 302 may dispatch one of UAVs 304 to transport a payload to a target location, and the UAV may autonomously navigate to the target location by utilizing various on-board sensors, such as a GPS receiver and/or other various navigational sensors.

Further, access system 302 may provide for remote operation of a UAV. For instance, access system 302 may allow an operator to control the flight of a UAV via its user interface. As a specific example, an operator may use access system 302 to dispatch one of UAVs 304 to a target location. The dispatched UAV may then autonomously navigate to the general area of the target location. At this point, the operator may use access system 302 to take control of the dispatched UAV and navigate the dispatched UAV to the target location (e.g., to a particular person to whom a payload is being transported). Other examples of remote operation of a UAV are also possible.

In an illustrative embodiment, UAVs 304 may take various forms. For example, each of UAVs 304 may be a UAV such as those illustrated in FIG. 1 or 2. However, UAV system 300 may also utilize other types of UAVs without departing from the scope of the invention. In some implementations, all of UAVs 304 may be of the same or a similar configuration. However, in other implementations, UAVs 304 may include a number of different types of UAVs. For instance, UAVs 304 may include a number of types of UAVs, with each type of UAV being configured for a different type or types of payload delivery capabilities.

UAV system 300 may further include remote device 306, which may take various forms. Generally, remote device 306 may be any device through which a direct or indirect request to dispatch a UAV can be made. Note that an indirect request may involve any communication that may be responded to by dispatching a UAV, such as requesting a package delivery. In an example embodiment, remote device 306 may be a mobile phone, tablet computer, laptop computer, personal computer, or any network-connected computing device. Further, in some instances, remote device 306 may not be a computing device. As an example, a standard telephone, which allows for communication via plain old telephone service (POTS), may serve as remote device 306. Other types of remote devices are also possible.

Further, remote device 306 may be configured to communicate with access system 302 via one or more types of communication network(s) 308. For example, remote device 306 may communicate with access system 302 (or a human operator of access system 302) by communicating over a POTS network, a cellular network, and/or a data network such as the Internet. Other types of networks may also be utilized.

In some embodiments, remote device 306 may be configured to allow a user to request pick-up of one or more items from a certain source location and/or delivery of one or more items to a desired location. For example, a user could request UAV delivery of a package to their home via their mobile phone, tablet, or laptop. As another example, a user could request dynamic delivery to wherever they are located at the time of delivery. To provide such dynamic delivery, UAV system 300 may receive location information (e.g., GPS coordinates, etc.) from the user's mobile phone, or any other device on the user's person, such that a UAV can navigate to the user's location (as indicated by their mobile phone).

In an illustrative arrangement, central dispatch system 310 may be a server or group of servers, which is configured to receive dispatch messages requests and/or dispatch instructions from access system 302. Such dispatch messages may request or instruct central dispatch system 310 to coordinate the deployment of UAVs to various target locations. Central dispatch system 310 may be further configured to route such requests or instructions to one or more local dispatch systems 312. To provide such functionality, central dispatch system 310 may communicate with access system 302 via a data network, such as the Internet or a private network that is established for communications between access systems and automated dispatch systems.

In the illustrated configuration, central dispatch system 310 may be configured to coordinate the dispatch of UAVs 304 from a number of different local dispatch systems 312. As such, central dispatch system 310 may keep track of which ones of UAVs 304 are located at which ones of local dispatch systems 312, which UAVs 304 are currently available for deployment, and/or which services or operations each of UAVs 304 is configured for (in the event that a UAV fleet includes multiple types of UAVs configured for different services and/or operations). Additionally or alternatively, each local dispatch system 312 may be configured to track which of its associated UAVs 304 are currently available for deployment and/or are currently in the midst of item transport.

In some cases, when central dispatch system 310 receives a request for UAV-related service (e.g., transport of an item) from access system 302, central dispatch system 310 may select a specific one of UAVs 304 to dispatch. Central dispatch system 310 may accordingly instruct local dispatch system 312 that is associated with the selected UAV to dispatch the selected UAV. Local dispatch system 312 may then operate its associated deployment system 314 to launch the selected UAV. In other cases, central dispatch system 310 may forward a request for a UAV-related service to one of local dispatch systems 312 that is near the location where the support is requested and leave the selection of a particular one of UAVs 304 to local dispatch system 312.

In an example configuration, local dispatch system 312 may be implemented as a computing system at the same location as deployment system(s) 314 that it controls. For example, a particular one of local dispatch system 312 may be implemented by a computing system installed at a building, such as a warehouse, where deployment system(s) 314 and UAV(s) 304 that are associated with the particular one of local dispatch systems 312 are also located. In other embodiments, the particular one of local dispatch systems 312 may be implemented at a location that is remote to its associated deployment system(s) 314 and UAV(s) 304.

Numerous variations on and alternatives to the illustrated configuration of UAV system 300 are possible. For example, in some embodiments, a user of remote device 306 could request delivery of a package directly from central dispatch system 310. To do so, an application may be implemented on remote device 306 that allows the user to provide information regarding a requested delivery, and generate and send a data message to request that UAV system 300 provide the delivery. In such an embodiment, central dispatch system 310 may include automated functionality to handle requests that are generated by such an application, evaluate such requests, and, if appropriate, coordinate with an appropriate local dispatch system 312 to deploy a UAV.

Further, some or all of the functionality that is attributed herein to central dispatch system 310, local dispatch system(s) 312, access system 302, and/or deployment system(s) 314 may be combined in a single system, implemented in a more complex system (e.g., having more layers of control), and/or redistributed among central dispatch system 310, local dispatch system(s) 312, access system 302, and/or deployment system(s) 314 in various ways.

Yet further, while each local dispatch system 312 is shown as having two associated deployment systems 314, a given local dispatch system 312 may alternatively have more or fewer associated deployment systems 314. Similarly, while central dispatch system 310 is shown as being in communication with two local dispatch systems 312, central dispatch system 310 may alternatively be in communication with more or fewer local dispatch systems 312.

In a further aspect, deployment systems 314 may take various forms. In some implementations, some or all of deployment systems 314 may be a structure or system that passively facilitates a UAV taking off from a resting position to begin a flight. For example, some or all of deployment systems 314 may take the form of a landing pad, a hangar, and/or a runway, among other possibilities. As such, a given deployment system 314 may be arranged to facilitate deployment of one UAV 304 at a time, or deployment of multiple UAVs (e.g., a landing pad large enough to be utilized by multiple UAVs concurrently).

Additionally or alternatively, some or all of deployment systems 314 may take the form of or include systems for actively launching one or more of UAVs 304. Such launch systems may include features that provide for an automated UAV launch and/or features that allow for a human-assisted UAV launch. Further, a given deployment system 314 may be configured to launch one particular UAV 304, or to launch multiple UAVs 304.

Note that deployment systems 314 may also be configured to passively facilitate and/or actively assist a UAV when landing. For example, the same landing pad could be used for takeoff and landing. Deployment system 314 could also include other structures and/or systems to assist and/or facilitate UAV landing processes.

Deployment systems 314 may further be configured to provide additional functions, including for example, diagnostic-related functions such as verifying system functionality of the UAV, verifying functionality of devices that are housed within a UAV (e.g., a payload delivery apparatus), and/or maintaining devices or other items that are housed in the UAV (e.g., by monitoring a status of a payload such as its temperature, weight, etc.).

In some embodiments, local dispatch systems 312 (along with their respective deployment system(s) 314 may be strategically distributed throughout an area such as a city. For example, local dispatch systems 312 may be strategically distributed such that each local dispatch systems 312 is proximate to one or more payload pickup locations (e.g., near a restaurant, store, or warehouse). However, local dispatch systems 312 may be distributed in other ways, depending upon the particular implementation.

As an additional example, kiosks that allow users to transport packages via UAVs may be installed in various locations. Such kiosks may include UAV launch systems, and may allow a user to provide their package for loading onto a UAV and pay for UAV shipping services, among other possibilities. Other examples are also possible.

In a further aspect, UAV system 300 may include or have access to user-account database 316. User-account database 316 may include data for a number of user accounts, and which are each associated with one or more person. For a given user account, user-account database 316 may include data related to or useful in providing UAV-related services. Typically, the user data associated with each user account is optionally provided by an associated user and/or is collected with the associated user's permission.

Further, in some embodiments, a person may be required to register for a user account with UAV system 300, if they wish to be provided with UAV-related services by UAVs 304 from UAV system 300. As such, user-account database 316 may include authorization information for a given user account (e.g., a user name and password), and/or other information that may be used to authorize access to a user account.

In some embodiments, a person may associate one or more of their devices with their user account, such that they can access the services of UAV system 300. For example, when a person uses an associated mobile phone to, e.g., place a call to an operator of access system 302 or send a message requesting a UAV-related service to a dispatch system, the phone may be identified via a unique device identification number, and the call or message may then be attributed to the associated user account. Other examples are also possible.

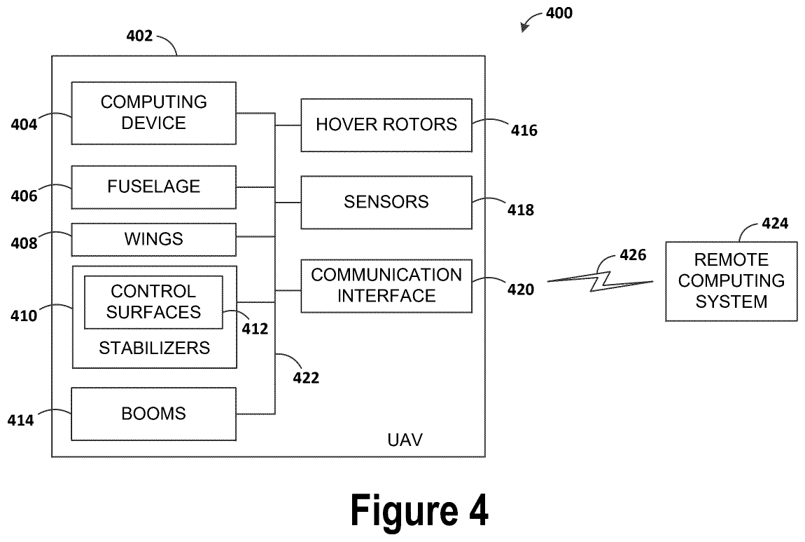

FIG. 4 is a block diagram illustrating a system for implementing deep stall control of a UAV. The example system, labeled as system 400, is an embodiment that exemplifies the principles described herein.

System 400 may perform operations to enhance the controlled descent of UAV 402. For instance, system 400 may enable UAV 402 to execute a deep stall control maneuver that transitions UAV 402 into a high drag configuration that may reduce the UAV's horizontal speed and also enable UAV 402 to descend at a more stable, reduced sink. The high drag configuration improves descent control relative to a nose-down configuration that UAV 402 may descend if adjustments are not performed onboard. This maneuver may be performed to help mitigate potential damage to UAV 402 in control tier failure situations.

As shown in FIG. 4, system 400 may include UAV 402 and remote computing system 424. In the example embodiment, UAV 402 is equipped with computing device 404, fuselage 406, wings 408, stabilizers 410 with control surfaces 412, booms 414, hover rotors 416, sensors 418, and communication interface 420. These components and other elements of UAV 402 may be interconnected via various wired and wireless connection technologies represented by connection mechanism 422 in FIG. 4. As further shown in FIG. 4, UAV 402 may engage in wireless communication 426 with remote computing system 424, potentially enabling the transfer of information and control instructions.

In some cases, system 400 may adopt different configurations with additional or alternative elements. For instance, remote computing system 424 may communicate with multiple UAVs in some implementations. Similarly, UAV 402 may have various configurations within examples, which may include various types of power supplies, payloads, and other components.

UAV 402 may represent various types of uncrewed aerial vehicles. In some implementations, UAV 402 may be designed to carry a payload, with the payload depending on the intended application of UAV 402. As such, UAV 402 may incorporate mechanisms for securing and potentially deploying the payload.

In some aspects, computing device 404 of UAV 402 may represent one or multiple types of computing devices that control various aspects of the UAV's operation. Computing device 404 may process data received from various sensors and systems located onboard UAV 402, interpreting this information to make informed decisions and issue appropriate commands that control the UAV's operation. These functions may include, but are not limited to, adjusting throttle, controlling pitch and yaw, and managing power distribution among various components. In addition, computing device 404 may use communication interface 420 to interact with remote computing system 424 and other external computing devices. This capability may enable real-time transmission of data and allow computing device 404 to receive control commands from remote computing system 424 and/or other external sources.

During operation, computing device 404 may be configured to detect a control tier failure at UAV 402, which may involve using sensor data and algorithms to monitor the systems and flight characteristics of UAV 402. For instance, computing device 404 may continuously analyze input from multiple sensors 418 distributed throughout UAV 402 and configured to provide data on the UAV's orientation, speed, altitude, position, and other relevant parameters. Computing device 404 may apply various algorithms to process sensor data and identify potential failure conditions. In some examples, computing device 404 may comprise one or more microprocessors, microcontrollers, or other suitable processing units capable of executing instructions and processing sensor data.

Fuselage 406 may serve as the main body of UAV 402 and can be designed to house computing device 404 and other components of UAV 402, such as sensors 418, communication interface 420, batteries (not shown), payloads and other potential components. In general, fuselage 406 can be designed to be robust and lightweight, ensuring the structural integrity of UAV 402 while also minimizing its overall weight for efficient flight. In some cases, fuselage 406 can be coupled onto the structural frame of UAV 402. For instance, fuselage 406 may connect to portions of a structural H-frame of UAV 402. The H-frame may include, within wings 408, a wing spar (not shown) and within booms 414, boom carriers (not shown).

Wings 408 extend outwardly from UAV 402, typically from both sides of fuselage 406 or another structure such as an H-frame. During operation, wings 408 provide lift, counteracting the weight of UAV 402 to enable ascent and altitude maintenance. The shape, size, and airfoil profile of wings 408 may vary depending on the desired flight characteristics. In some cases, wings 408 may incorporate control surfaces like ailerons or flaps for additional flight control. Wings 408 can be constructed from materials such as composites, metals, or lightweight polymers, balancing strength and weight considerations.

Wings 408 may serve as mounting points for components, such as booms 414, propulsion systems, or sensors 418. In some implementations, wings 408 may be fixed relative to the fuselage, while in others, they may be adjustable or foldable for compact storage or transport. As such, the precise configuration and features of fuselage 406 and wings 408 are tailored to suit the intended application and performance requirements of the specific UAV design.

UAV 402 includes one or multiple stabilizers 410, each comprising a fixed portion and an adjustable control surface 412. Stabilizers 410 may be attached directly to fuselage 406 or mounted on booms 414 extending from wings 408. For instance, the positioning of booms 414 can be adjusted to optimize aerodynamic performance and stability while also positioning stabilizers 410 in a configuration that optimizes performance of UAV 402. In some examples, a pair of stabilizers 410 are arranged to form a V-tail configuration for UAV 402 when viewed from behind, with the fixed portions extending diagonally in a vertical direction from fuselage 406 or booms 414.

Control surfaces 412 can adjust position (e.g., rotate) relative to the fixed portions, deflecting through a range of angles from flat alignment to perpendicular positioning. The size and shape of control surfaces 412 may vary based on the design requirements of UAV 402, influencing their effectiveness at different angles. In some cases, stabilizers 410 may be referred to as ruddervators that combine rudder and elevator functions. Their size, shape, and angle can be adjusted to optimize stability, control characteristics, and stall behavior. A wider V-angle may enhance lateral stability, while a narrower angle may improve pitch control.

The design and construction of stabilizers 410 may balance strength, weight, and aerodynamic performance, using materials such as composites, metals, or advanced polymers. Internal structures or reinforcements may be incorporated to maintain rigidity while minimizing weight. The connection between control surfaces 412 and fixed portions may use hinges, bearings, or flexible materials. Actuation mechanisms, like servos or hydraulic systems, may be used to adjust control surfaces 412, with the choice of actuation mechanism depending on the size and power requirements of UAV 402.

During normal flight, control surfaces 412 may align flat with the fixed portions to minimize drag. Upon detecting a control tier failure, computing device 404 may adjust their angle, potentially to a perpendicular position relative to the fixed portion of each stabilizer 410. This transition may be gradual to manage aerodynamic forces. In some cases, control surfaces 412 may have over-center capability for additional control authority, with mechanical stops preventing over-stressing. The material and construction of control surfaces 412 may be chosen to withstand rapid deflection forces and maintain position during descent.

In some examples, booms 414 extend parallel to fuselage 406 and perpendicular to wings 408, providing structural support and mounting points for components. Their length, shape, and construction vary based on UAV 402's design requirements. Booms 414 may also serve as conduits for wiring or control cables. As such, stabilizers 410 may be physically separate components on UAV 402, allowing independent adjustment and potentially reducing airflow interference. Some example implementations may include folding mechanisms for easier storage and transportation.

UAV 402 may include one or multiple booms 414. Typically, a first boom is coupled to one wing and a second boom to the other wing of the pair of wings 408. Booms 414 may extend parallel to fuselage 406 and perpendicular to their respective wings, providing structural support and serving as mounting points for additional components. The length and cross-sectional shape of booms 414 can vary based on UAV 402's design requirements. They may be cylindrical or have an airfoil-like cross-section to reduce drag. Booms 414 may be constructed from lightweight yet strong materials, such as carbon fiber composites or aluminum alloys, to maintain structural integrity while minimizing weight.

The method of coupling booms 414 to the wings varies. For instance, booms 414 may be rigidly attached using bolts, adhesives, or a combination of fastening methods. Some implementations incorporate vibration-damping elements to reduce vibration transmission between booms 414 and wings 408. The orientation of booms 414 can be critical for maintaining desired flight characteristics. They are precisely aligned parallel to the fuselage's longitudinal axis for symmetry and balance, while their perpendicular orientation to wings 408 helps distribute loads evenly. Booms 414 may also serve multiple purposes beyond structural support, acting as conduits for electrical wiring or control cables, and providing attachment points for additional control surfaces, sensors, or mission-specific equipment. Their length may be optimized or made adjustable to position rear-mounted components ideally, minimizing interference between wing airflow and stabilizer effectiveness.

In some examples, a first stabilizer of a pair of stabilizers 410 may be coupled to the end of the first boom, and a second stabilizer to the end of the second boom, both positioned relative to the rear of fuselage 406. This configuration can allow precise positioning of stabilizers 410 to optimize aerodynamic performance and control effectiveness. The coupling method may vary, using rigid attachments or incorporating vibration-damping elements. The positioning of stabilizers 410 relative to the fuselage may be adjustable, allowing fine-tuning of stability and control characteristics. The distance between stabilizers 410 and fuselage 406 can influence factors like pitch stability and control authority.

The first and second stabilizers may be physically separate components, offering benefits such as independent adjustment or replacement, simplified maintenance, enhanced reliability, and reduced airflow interference. The gap between stabilizers 410 may vary depending on the UAV's design, balancing interference reduction and overall compactness. Each stabilizer's shape and size may be tailored to its position, with inboard edges shaped for fuselage clearance and outboard edges designed to minimize tip vortices and drag. Some implementations include folding or collapsing mechanisms for easier storage or transportation, with secure deployment for flight. The material composition of stabilizers 410 aims to balance weight, strength, and aerodynamic performance, often using composite materials like carbon fiber reinforced polymers. Different materials or construction methods for each stabilizer may allow fine-tuning of the UAV's balance and flight characteristics.

UAV 402 may include hover rotors 416 coupled to various locations on UAV 402 like distributed on booms 414. These rotors provide vertical lift during takeoff, landing, and hover operations. A first plurality of hover rotors 416 may be coupled to the first boom, and a second plurality to the second boom. The number and positioning of rotors on each boom may depend on the UAV's size, weight, and lift requirements, optimized for balance and stable flight characteristics.

Upon detecting a control tier failure, computing device 404 may trigger hover rotors 416 to freely rotate or windmill. This windmilling effect, caused by airflow during descent, increases drag on UAV 402, potentially reducing descent velocity. In some cases, computing device 404 may selectively enable windmilling for a subset of rotors based on factors such as speed, altitude, or desired descent rate. Fewer windmilling rotors may result in faster descent, while more may provide greater drag and slower descent. The windmilling speed can be controlled through methods like partial braking or adjusting variable-pitch rotor blades, allowing fine-tuning of drag production. Windmilling may be initiated gradually or in stages to maintain stability and allow precise control over the descent profile.

The design of hover rotors 416 influences their windmilling effectiveness. Rotor blade shape, size, and pitch may be optimized for both powered flight and efficient drag generation when windmilling. The material composition may be selected to withstand forces during rapid transitions between powered and windmilling states. Some implementations may include mechanisms to lock rotors in specific positions when not in use, which can be disengaged for windmilling during uncontrolled descent. Computing device 404 may manage these transitions based on detected flight conditions and control tier status.

Sensors 416 may be designed to detect and measure a variety of physical properties for UAV 402 as well as the surrounding environment. The properties may include altitude, which is the vertical distance of UAV 402 from the ground or another reference point and speed, which is the rate at which UAV 402 is moving. In addition, sensors 416 may also measure temperature, which can affect the performance of the components of UAV 402 and pressure, which can influence the flight characteristics of UAV 402. Sensors 416 may be used to provide other information to computing device 404.

The data collected by sensors 416 are relayed in real-time to computing device 404, which may then interpret and use the sensor data to control the operations of UAV 402. For instance, if the sensor data conveys a change in altitude or speed, computing device 404 may adjust control surfaces 412 or throttle setting to maintain a stable flight. Similarly, if the sensors detect a change in temperature or pressure, computing device 404 may adjust the operations of UAV 402 to optimize performance under the new conditions. As such, computing device 404 may receive input from multiple sensors 416 distributed throughout the UAV. These sensors may include, but are not limited to, accelerometers, gyroscopes, altimeters, airspeed sensors, and GPS receivers. In some cases, sensors 416 may provide data on orientation, speed, altitude, and position of UAV 402, enabling computing device 404 to continuously monitor and analyze the sensor data to detect anomalies or deviations from expected flight parameters that may indicate a control tier failure.

In some aspects, computing device 404 may use algorithms to process the sensor data and identify potential failure conditions. The algorithms may vary in complexity and may include simple threshold checks, statistical analysis, or more advanced machine learning techniques. For example, a sudden loss of altitude or unexpected changes in attitude may trigger a failure detection. Computing device 404 may also monitor internal systems of UAV 402, such as the flight control surfaces, propulsion systems, and power distribution. In some implementations, built-in test equipment (BITE) may be integrated into these systems to provide real-time health and status information to computing device 404. Anomalies detected in these internal systems may also contribute to the identification of a control tier failure. In some cases, computing device 404 may use a combination of sensor data and system status information to make a determination of control tier failure. This multi-faceted approach may help reduce false positives and increase the reliability of failure detection.

Upon detecting a control tier failure, computing device 404 may be configured to initiate a deep stall maneuver by adjusting one or multiple control surfaces 412 of stabilizers 410. In some cases, this adjustment may be a single, pre-programmed command to move control surfaces 412 to a specific angle. In other cases, computing device 404 may dynamically calculate the optimal control surface angle based on current flight conditions and status for UAV 402. In addition, computing device 404 may also be capable of adapting its failure detection and response strategies based on the specific phase of flight or mission profile. For example, different criteria may be used to identify a failure during takeoff, cruise, or landing phases. This adaptive approach may allow for more nuanced and appropriate responses to potential failure conditions.

In the event of a control tier failure, the sensor data from sensors 418 can be particularly useful. In particular, computing device 404 can use sensor data to determine the current state of UAV 402 and implement appropriate measures, such as the deep stall maneuver, to safely control the descent of UAV 402. The use of sensor data can help ensure that the response by UAV 402 to a control tier failure is informed by the real-time conditions experienced by UAV 402, enhancing the safety and reliability of operations.

Communication interface 420 enables UAV 402 to communicate with external devices, such as remote computing system 424. In particular, communication interface 420 may be designed to facilitate wireless communication, eliminating the constraints of wired connections and enabling UAV 402 to operate freely in its environment. As such, communication interface 420 can support various wireless communication technologies, such as radio waves, infrared, satellite, or cellular networks, providing flexibility in the choice of communication method based on the operational requirements and environmental conditions. Communication interface 420 may also be responsible for transmitting and receiving data between UAV 402 and remote computing system 424. This data can include control commands from remote computing system 424 to UAV 402, sensor data from UAV 402 to remote computing system 424, and other relevant information. Communication interface 420 may be designed to ensure that this data is transmitted reliably and accurately, contributing to the overall performance and safety of the operations of UAV 402.

In the event of a control tier failure, communication interface 420 can play a particularly valuable role, which may involve transmitting data about the status and conditions of UAV 402 to remote computing system 424. This can enable remote computing system 424 to monitor the situation and take appropriate actions. Furthermore, communication interface 420 can receive commands from remote computing system 424 to implement recovery mechanisms, such as the deep stall maneuver, to safely control the descent of UAV 402.

In some examples, UAV 402 may be designed to maintain a constant communication link with remote computing system 424. This communication link, denoted as wireless communication 426, is established using one or multiple wireless communication technologies, such as radio waves, infrared, satellite, or cellular networks. Wireless communication allows for real-time data exchange between UAV 402 and remote computing system 424, which can include sensor readings, flight status, and other operational data. Conversely, remote computing system 424 can send control commands to UAV 402, instructing UAV 402 to adjust its flight path, change its altitude, or perform other maneuvers. The two-way communication link enables remote computing system 424 to monitor operations of UAV 402 in real-time and make adjustments as and when they are deemed appropriate. This real-time control and monitoring capability is particularly beneficial in scenarios involving control tier failures, as it allows for immediate response and corrective action, thereby enhancing the safety and reliability of UAV 402's operations.

As shown in FIG. 4, components of UAV 402 are interconnected via connection mechanism 422. Connection mechanism 422 includes wired and wireless technologies that enable components of UAV 402 to communicate with each other. In addition to wired and wireless connections, connection mechanism 422 may also include a complex system of fasteners, joints, and other connecting elements that securely hold the various components of the UAV together. Connection mechanism 422 can ensure that the components of UAV 402 are firmly attached to each other, maintaining the structural integrity of the UAV and ensuring seamless operation. Connection mechanism 422 is designed to withstand the stresses and strains experienced by the UAV during flight, ensuring that UAV 402 remains intact and operational even under challenging conditions.

In other embodiments, system 400 may include more or fewer components. For instance, remote computing system 424 may be designed to communicate with multiple UAVs simultaneously, enabling the control of a fleet of UAVs. Furthermore, UAV 402 can have different configurations within examples. This flexibility allows UAV 402 to be tailored to specific operational scenarios or requirements, enhancing its versatility and adaptability.

In some examples, computing device 404 may include redundant processing units or backup systems to ensure continued operation in the event of a partial system failure. This redundancy may help maintain the ability to detect and respond to control tier failures even if some components of the system are compromised. In some aspects, upon detecting a control tier failure, computing device 404 may adjust the control surface of each stabilizer from a first angle to a second angle. This adjustment may not necessarily occur instantaneously, but rather over a period of time. The rate of adjustment may be controlled to manage the transition into the deep stall maneuver more smoothly. For instance, computing device 404 may be programmed to adjust the control surfaces gradually, moving them from the first angle to the second angle over a predetermined duration. This gradual adjustment may help reduce sudden changes in altitude and flight characteristics experienced by UAV 402. The duration of the adjustment may vary depending on factors such as UAV 402's current speed, altitude, and the severity of the control tier failure. The adjustment rate may be linear in some cases, with the control surfaces moving at a constant speed from the first angle to the second angle. In other implementations, the adjustment rate may be non-linear. For example, the movement may start slowly, accelerate in the middle, and then slow down as it approaches the final position. This non-linear adjustment may help manage the aerodynamic forces acting on UAV 402 during the transition.

In some aspects, computing device 404 may dynamically adjust the rate of control surface movement based on real-time feedback from sensors 418. For instance, if UAV 402 begins to experience unexpected behavior during the transition, computing device 404 may slow down or temporarily pause the adjustment to stabilize UAV 402 before continuing. Computing device 404 may also be configured to adjust each control surface independently. In some implementations, one control surface may be adjusted more quickly or to a different final angle than the other, depending on the specific flight conditions or failure mode detected. This independent adjustment may provide finer control over descent characteristics of UAV 402. In some cases, the adjustment of control surfaces 412 may be coordinated with other actions, such as reducing power to the propulsion systems or activating the windmilling of hover rotors 416. The timing and sequencing of these actions may be managed by computing device 404 to achieve the desired descent profile.

The method of actuating control surfaces 412 during this adjustment period may vary. In some implementations, servo motors may be used to provide precise control over the movement rate. In other cases, hydraulic or pneumatic systems may be used, particularly for larger UAVs where greater force may be required to move control surfaces 412 against aerodynamic loads. For instance, by adjusting control surfaces 412 over a period of time rather than instantaneously, UAV 402 may be able to transition more smoothly into the deep stall maneuver. This approach may help maintain stability during the initial stages of the maneuver and potentially reduce stress on UAV 402.

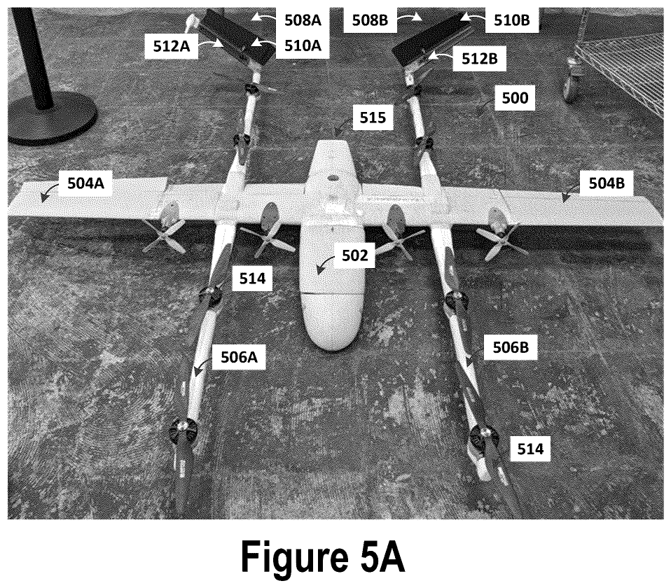

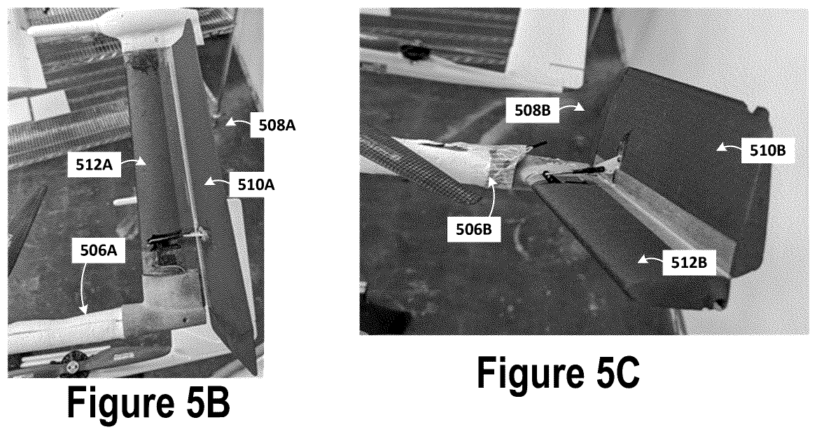

FIG. 5A illustrates a UAV 500 with stabilizers configured for a deep stall maneuver. As shown in the example embodiment, UAV 500 may comprise several interconnected components that work together to enable flight and control. UAV 500 can have other configurations in different examples.

Fuselage 502 may serve as the main body of UAV 500, potentially housing various internal components such as the computing device, sensors, and power systems. In some implementations, fuselage 502 may be designed to minimize drag while providing sufficient internal space for necessary equipment and potential payloads. Wings 504A and 504B are shown extending outwardly from fuselage 502, one on each side. These wings may provide lift during forward flight. In some cases, wings 504A and 504B may be fixed-wing structures, while in other implementations, they may be adjustable or foldable. In addition, booms 506A and 506B may extend rearward from wings 504A and 504B, respectively. These booms may be elongated structures that provide support for other components and potentially house additional systems or wiring. In some aspects, booms 506A and 506B may be aligned parallel to the longitudinal axis of fuselage 502.

Stabilizers 508A and 508B may be attached to the rear ends of booms 506A and 506B respectively. Rear ends of booms 506A and 506B are positioned by rear portion 515 of fuselage 502. Stabilizers 508A and 508B may be arranged in a V-tail configuration, extending diagonally upward and outward from the rear ends of booms 506A and 506B. This V-shaped arrangement may provide both lateral and longitudinal stability during normal flight operations. Each stabilizer may comprise a fixed portion (e.g., fixed portions 512A, 512B) and an adjustable control surface (e.g., control surfaces 510A, 510B). Control surfaces 510A and 510B may be movable surfaces attached to the trailing edges of fixed portions 512A and 512B. These control surfaces may be adjusted to different angles relative to the fixed portions, allowing for control of UAV 500's pitch and yaw.

In addition, hover rotors 514 may be mounted on booms 506A and 506B. In some implementations, multiple hover rotors 514 may be present on each boom 506A, 506B. These rotors may provide vertical lift for takeoff, landing, and hover operations, and may also be used during the deep stall maneuver.

The connection between these components may vary depending on the specific design of UAV 500. In some aspects, wings 504A and 504B may be rigidly attached to fuselage 502 using bolts, adhesives, or a combination of fastening methods. Booms 506A and 506B may be similarly attached to wings 504A and 504B, potentially with additional reinforcement to handle the loads from hover rotors 514 and stabilizers 508A and 508B. In addition, stabilizers 508A and 508B may be securely fastened to the ends of booms 506A and 506B, with the connection designed to withstand the forces experienced during flight and maneuvering. The attachment of control surfaces 510A and 510B to fixed portions 512A and 512B may involve hinges or other mechanisms that allow for controlled movement while maintaining structural integrity. Hover rotors 514 may be mounted to booms 506A and 506B using brackets or specially designed attachment points that allow for secure fastening while potentially incorporating vibration damping elements.

Stabilizers 508A and 508B may be positioned to induce a deep stall maneuver by UAV 500 when control surfaces 510A and 510B are adjusted to an angle substantially perpendicular to fixed portions 512A and 512B. When a deep stall maneuver is initiated, control surfaces 510A and 510B may be rotated to a position approximately perpendicular to their respective fixed portions 512A and 512B as shown. In this configuration, the control surfaces may act as large air brakes or spoilers. With control surfaces 510A and 510B in this perpendicular position, they may significantly disrupt the airflow over stabilizers 508A and 508B. This disruption of the airflow may cause a substantial increase in drag and a loss of lift over the tail section of UAV 500. The increased drag at the rear of UAV 500 may cause the nose of the aircraft to pitch upward, potentially increasing the angle of attack of wings 504A and 504B beyond their critical angle. This high angle of attack may result in the wings stalling, further reducing lift and increasing drag. The combination of stalled wings and the high-drag configuration of stabilizers 508A and 508B with perpendicularly positioned control surfaces 510A and 510B may induce a stable deep stall condition. In this state, UAV 500 may descend at a lower sink rate while maintaining a relatively low forward speed.

The V-tail configuration of stabilizers 508A and 508B may help maintain directional stability during the deep stall maneuver. The angled positioning of the stabilizers may continue to provide some lateral control authority, potentially allowing for limited steering even in the stalled condition. In some implementations, the exact angle of control surfaces 510A and 510B may be dynamically adjusted by UAV 500's computing device to fine-tune the descent characteristics based on factors such as altitude, airspeed, and environmental conditions.

FIG. 5B depicts a focused perspective view of stabilizer 508A configured for a deep stall maneuver. In this configuration, control surface 510A is positioned at an open angle, substantially perpendicular to the fixed portion 512A of stabilizer 508A. This arrangement is designed to disrupt airflow and induce the deep stall condition. Stabilizer 508A is shown positioned at an end of boom 506A.

FIG. 5C presents a similar focused perspective view, but of stabilizer 508B. In this image, control surface 510B is likewise positioned at an open angle, substantially perpendicular to the fixed portion 512B of stabilizer 508B. This configuration mirrors that of stabilizer 508A, collectively enabling the UAV to enter and maintain a deep stall maneuver. Stabilizer 508C is shown positioned at an end of boom 506B. As shown, fixed portions 512A, 512B may extend in a direction away from fuselage 502 or the booms in a vertical diagonal direction, forming the characteristic V-shape when viewed from behind UAV 500.

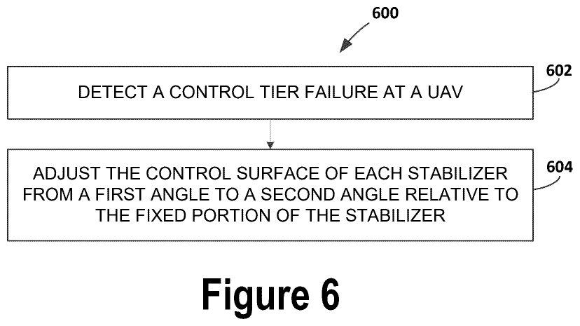

FIG. 6 is a flow chart of a method for implementing deep stall control of a UAV. Method 600 may include one or more operations, functions, or actions, as depicted by one or more of block 602 and block 604, each of which may be carried out by any of the systems shown in prior figures, among other possible systems.

Those skilled in the art will understand that the flow charts described herein illustrate functionality and operation of certain implementations of the present disclosure. In this regard, each block of the flowchart may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art.

At block 602, method 600 involves detecting a control tier failure at an UAV. A computing device may detect the control tier failure at the UAV. In some examples, the computing device is located onboard the UAV. In other examples, the computing device is positioned remote from the UAV.

In some aspects, the computing device may detect a control tier failure at a UAV through various methods and sensor inputs. The UAV may include one or more sensors coupled to the aircraft to provide data for detecting control tier failures. These sensors may include, but are not limited to, accelerometers, gyroscopes, magnetometers, airspeed sensors, and GPS receivers. The type, number, and placement of sensors may vary depending on the specific UAV design and its intended applications.

The detection process may involve analyzing data from multiple sources and comparing it against expected values or patterns. In some implementations, the computing device may monitor the response of control surfaces to commands. If a control surface fails to move as expected when given a command, this may indicate a control tier failure. For example, if the computing device sends a signal to adjust an aileron, but position sensors indicate no movement, this discrepancy may trigger a failure detection. The computing device may also analyze data from inertial measurement units (IMUs) to detect unexpected changes in the UAV's attitude or angular rates. In some cases, if the UAV's roll, pitch, or yaw rates deviate significantly from the expected values based on control inputs, this may suggest a control system malfunction. In some cases, the computing device may compare GPS data with other sensor readings to identify potential failures. For instance, if GPS indicates the UAV is descending rapidly while other sensors suggest level flight, this inconsistency may indicate a control problem.

The computing device may also monitor the UAV's response to control inputs over time. In some implementations, if the aircraft consistently fails to achieve the desired attitude or trajectory despite correct control inputs, this may be interpreted as a control tier failure. Additionally, in some cases, the computing device may analyze power consumption patterns of servos and actuators. Unusual spikes or drops in power draw may indicate mechanical failures in the control system. The computing device may also monitor communication links between different components of the control system. In some aspects, if critical data streams are interrupted or contain corrupted data, this may trigger a control tier failure detection.

In some examples, the computing device may use machine learning algorithms to detect subtle anomalies in the UAV's behavior that may indicate an impending control failure. These algorithms may be trained on data from both normal operations and simulated failure scenarios. The computing device may also monitor structural health indicators. In some cases, excessive vibration or strain detected by accelerometers or strain gauges may suggest a mechanical failure that could compromise control effectiveness. In some aspects, the computing device may perform periodic built-in tests of control system components. Failure of any component to pass these tests may be interpreted as a potential control tier failure.

The configuration of the UAV can differ within examples. For instance, the UAV may include a fuselage, a pair of wings extending outwardly from the fuselage, and one or more stabilizers with each stabilizer having a control surface and a fixed portion. In some examples, the UAV includes a pair of stabilizers arranged in a V-shape configuration where each stabilizer has a control surface that is adjustable relative to a fixed portion of the stabilizer. In some cases, the pair of stabilizers that are arranged in the V-shape configuration form a V-tail of the UAV where each stabilizer extends in a vertical diagonal direction away from a longitudinal axis of the fuselage.

When positioned at the first angle, the control surface of each stabilizer is aligned substantially flat along the fixed portion of the stabilizer. Each control surface is positioned at the first angle during forward travel by the UAV. When positioned at the second angle, the control surface of each stabilizer is substantially perpendicular to the fixed portion of the stabilizer.

At block 604, method 600 involves adjusting the control surface of each stabilizer from a first angle to a second angle relative to the fixed portion of the stabilizer. In some aspects, the UAV may adjust the angle of the control surface of each stabilizer relative to the fixed portion through various mechanisms and processes. As an example, the UAV may use servo motors to adjust the control surface angles. For instance, servo motors may be directly coupled to the control surfaces, allowing for precise and rapid adjustments. The computing device may send electrical signals to the servo motors, specifying the desired angle of deflection.

In some cases, the UAV may use hydraulic actuators to move one or more control surfaces of the stabilizers. The actuators may provide greater force for larger UAVs or in high-speed conditions where aerodynamic loads are significant. The computing device may control hydraulic valves to direct fluid flow and adjust the control surface positions. Similarly, some example UAVs may use electromechanical actuators that combine electric motors with mechanical linkages, which may offer a balance between the precision of electric systems and the power of hydraulic systems. The computing device may control the electric motors to achieve the desired control surface angles. In other examples, the UAV may use shape memory alloys or piezoelectric materials to adjust control surface angles. The materials may change shape or dimensions in response to electrical signals, potentially allowing for more compact or lightweight control systems.

In some aspects, upon detecting a control tier failure, the computing device may adjust the control surface of each stabilizer from a first angle to a second angle. This adjustment may not necessarily occur instantaneously, but rather over a period of time. The rate of adjustment may be controlled to manage the transition into the deep stall maneuver more smoothly.

In some implementations, the computing device may be programmed to adjust the control surfaces gradually, moving them from the first angle to the second angle over a predetermined duration. This gradual adjustment may help reduce sudden changes in the UAV's attitude and flight characteristics. The duration of the adjustment may vary depending on factors such as the UAV's current speed, altitude, and the severity of the control tier failure.

During operation, the UAV may use a combination of position sensors and feedback control loops to accurately set and maintain control surface angles. In some examples, rotary or linear potentiometers may provide position feedback, which can enable the computing device to verify and fine-tune the control surface angles. In some cases, the UAV may use a differential gear system to adjust the control surfaces. This mechanical approach may allow for precise control and potentially provide some level of control even in the event of partial actuator failure. In some aspects, the UAV may utilize distributed actuation systems, with multiple smaller actuators working in concert to adjust the control surface angle. This approach may provide redundancy and allow for more complex control surface deformations.

In addition, the computing device may implement rate limiting in the control surface adjustment process. In some cases, this may prevent overly rapid changes that could induce structural loads or cause instability, especially during the transition into a deep stall maneuver. In some implementations, the UAV may use adaptive control algorithms to adjust the control surface angles. The algorithms may take into account factors such as airspeed, altitude, and detected control tier failures to optimize the control surface positions for the current flight conditions.

In some examples, the UAV includes a first boom coupled to a first wing of the pair of wings. The first boom extends in a direction substantially parallel to the fuselage of the UAV and perpendicular to the first wing. The UAV also includes a second boom coupled to a second wing of the pair of wings. The second boom extends in the direction substantially parallel to the fuselage of the UAV and perpendicular to the second wing. A first stabilizer of the pair of stabilizers is coupled to an end of the first boom that is positioned relative to a rear of the fuselage and a second stabilizer of the pair of stabilizers is coupled to an end of the second boom that is positioned relative to the rear of the fuselage. In such a configuration, the first stabilizer and the second stabilizer are physically separate.

The UAV may adjust both of the first control surface and the second control surface from the first angle to the second angle based on detecting the control tier failure at the UAV. For instance, when the first control surface and the second control surface are adjusted to the second angle, each control surface may be positioned substantially perpendicular to a longitudinal axis of the UAV.

In some examples, method 600 further involves triggering, based on detecting the control tier failure at the UAV, hover rotors to freely rotate. Each hover rotor can be coupled to either the first boom or the second boom.

In some examples, method 600 may further involve determining a speed, an altitude, and a weight of the UAV. Method 600 may further involve selecting the second angle based on the speed, the altitude, and the weight of the UAV. In some cases, method 600 may involve using a subset of information about the UAV to select the second angle. For instance, the computing system may select the second angle based on the speed and the altitude of the UAV. In other cases, the weight may also be factored.

In some aspects, the entry conditions, implementation, and recovery mechanisms for the uncontrolled descent or stall maneuver of a UAV may vary, providing a range of options for managing control tier failures and enhancing safety and reliability in UAV operations. The UAV may be in different flight modes when the stall maneuver is initiated, including hover mode (stationary or slow-moving), cruise mode (high speed), or transition mode (between hover and cruise). The altitude may range from a few meters to several hundred meters or more above the ground, while the speed may vary from low speeds typical of hover mode to high speeds typical of cruise mode. These factors may affect the UAV's behavior during the maneuver and the resulting descent characteristics.

The stall maneuver may be implemented through various methods, such as adjusting throttle or changing aircraft pitch to induce a stall, deflecting the stabilizer and allowing hover rotors to windmill, or using a stepwise or continuous implementation of stabilizer deflection. The maneuver may be triggered by specific conditions, such as control tier failure, loss of communication with the ground control station, breach of a predefined geofence, or manual command from a pilot or operator.

Different systems may be used to stabilize the UAV and arrest the descent during recovery. These may include an automatic flight control system that adjusts control surfaces, throttle, or pitch or a manual control system allowing pilot input through remote control or onboard interface. In some cases, a hybrid control system combining automatic and manual control capabilities may be used. Additional recovery assistance may include a parachute system for slowing descent and cushioning impact, or airbags and other impact-absorbing devices for protection during landing.

By adjusting these various aspects, the UAV can be tailored to respond effectively to different operational scenarios or requirements, offering enhanced safety and reliability in UAV operations. The flexibility in entry conditions, implementation methods, and recovery mechanisms allows for a comprehensive approach to managing potential control tier failures across a wide range of flight situations.

In some cases, the computing device may be programmed with multiple strategies for selecting the second angle based on speed and altitude. The specific strategy used may depend on factors such as the nature of the control tier failure, the UAV's current mission phase, or environmental conditions. This flexibility may allow the system to adapt to a wide range of potential failure scenarios.

In some examples, accelerometers may measure the UAV's acceleration forces in multiple axes. For instance, three-axis accelerometers may be used to detect sudden changes in acceleration that could indicate a loss of control or unexpected flight behavior. Gyroscopes may measure the UAV's angular velocity and orientation. These sensors may help identify unusual rotations or altitude changes that may be associated with control tier failures. In some cases, magnetometers may be used to measure the Earth's magnetic field and assist in determining the UAV's heading. Sudden or unexpected changes in heading data could potentially indicate a control system malfunction. For example, airspeed sensors, such as pitot tubes or differential pressure sensors, may provide information on the UAV's velocity relative to the surrounding air. Anomalies in airspeed data may suggest issues with the UAV's propulsion or control systems. In addition, GPS receivers may be used to determine the UAV's position, altitude, and ground speed. In some cases, discrepancies between GPS data and other sensor readings may help identify potential control tier failures. For example, if the GPS indicates the UAV is descending rapidly while other sensors suggest level flight, this could trigger a failure detection algorithm.

The computing device may continuously monitor and analyze data from these sensors. In some aspects, sensor fusion algorithms may be used to combine data from multiple sources, potentially improving the accuracy and reliability of failure detection. The computing device may compare sensor data against expected values or patterns based on the UAV's current flight mode and commands. In some examples, the sensors may be distributed throughout the UAV to provide redundancy and a more comprehensive picture of the aircraft's state. For example, multiple accelerometers may be placed at different locations on the airframe to detect localized vibrations or structural issues that could contribute to control tier failures.

The sampling rate and resolution of the sensors may vary depending on the specific requirements of the UAV system. In some cases, high-frequency sampling may be used to detect rapid changes in flight dynamics that could indicate a failure. In addition, the computing device may apply filtering techniques to sensor data to reduce noise and improve the reliability of failure detection algorithms. The sensors may be designed to operate reliably in various environmental conditions, such as extreme temperatures or high humidity. Protective housing and calibration procedures may be used to ensure consistent sensor performance.

The sensor data may not only be used for detecting control tier failures but may also inform the UAV's response to such failures. For example, accelerometer and gyroscope data may help determine the effectiveness of the deep stall maneuver and guide adjustments to the control surface angles during descent. In some aspects, the computing device may be configured to determine the second angle for the control surfaces based on multiple factors including the UAV's altitude, speed, weight, and wind conditions. The multi-factor approach may allow for more precise control of the UAV's descent characteristics during a deep stall maneuver. The altitude of the UAV may influence the selection of the second angle. In some cases, at higher altitudes, the computing device may choose a more aggressive angle to induce a deeper stall and reduce forward speed more quickly. At lower altitudes, a less extreme angle may be selected to maintain some degree of control authority.

The speed of the UAV may also play a role in determining the second angle. In certain aspects, for higher speeds, the computing device may select a larger deflection angle to rapidly reduce velocity. For lower speeds, a smaller angle may be sufficient to maintain the desired descent profile. The weight of the UAV may be considered when calculating the second angle. In some cases, a heavier UAV may require a larger control surface deflection to achieve the same stall characteristics as a lighter aircraft. The computing device may adjust the angle based on the current weight, which may vary depending on payload or fuel status. Wind conditions may significantly affect the UAV's descent and may be factored into the angle determination. In some implementations, the computing device may use data from onboard sensors or weather forecasts to assess wind speed and direction. For strong headwinds, a smaller angle may be selected to prevent the UAV from descending too slowly or even moving backwards. In tailwind conditions, a larger angle may be chosen to counteract the additional forward speed imparted by the wind.

The computing device may use various methods to process these factors and determine the second angle. In some aspects, lookup tables may be used, with pre-calculated angles for different combinations of altitude, speed, weight, and wind conditions. In other implementations, mathematical models or algorithms may be used to compute the optimal angle in real-time. In addition, the determination of the second angle may be a dynamic process in certain cases. The computing device may continuously update the angle as conditions change during the descent. This adaptive approach may help maintain optimal descent characteristics throughout the maneuver. In some examples, the computing device may use machine learning techniques to refine its angle selection over time. By analyzing data from multiple flights and descent events, the system may improve its ability to choose the most effective angle for various combinations of conditions.

In some examples, the precision with which the second angle can be set may vary depending on the actuation system used for the control surfaces. For instance, high-precision servo motors may allow for fine adjustments to the angle, while other systems may be limited to broader increments. The control surfaces of the stabilizers may be adjustable across a range of angles comprising the first angle and the second angle. This range of adjustability may provide flexibility in managing the UAV's flight characteristics and descent profile during normal operations and contingency maneuvers. The specific range of angles may vary depending on the design of the UAV and its intended applications. In some implementations, the control surfaces may be capable of deflecting through a range of 0 to 90 degrees relative to the fixed portion of the stabilizer. In other cases, the range may extend beyond 90 degrees, potentially allowing for over-center positioning of the control surfaces. The precision with which the control surfaces can be positioned within this range may depend on the actuation system used. In some aspects, high-precision servo motors may allow for fine adjustments in small increments, potentially as small as 0.1 degrees. Other systems may have coarser adjustment capabilities, with increments of several degrees between possible positions.

The rate at which the control surfaces can move through this range of angles may also vary. In some implementations, rapid actuation may be possible, allowing for quick transitions between different angles. In other cases, the movement may be more gradual to manage aerodynamic forces and prevent sudden changes in the UAV's altitude. The ability to adjust the control surfaces across a range of angles may allow for more nuanced control during different phases of flight. For example, during normal cruise flight, small deflections within a limited range may be used for trim adjustments. In contrast, during a deep stall maneuver, larger deflections towards the extreme end of the range may be used. In some aspects, the range of adjustability may not be symmetrical. For instance, the control surfaces may be capable of greater upward deflection than downward deflection. This asymmetry may be designed to optimize the UAV's performance characteristics for its intended mission profile. The material properties and construction of the control surfaces and their attachment points may be selected to withstand the forces experienced across the full range of deflection angles. In some implementations, stops or limiters may be incorporated to prevent over-deflection beyond the designed range, protecting the control surfaces and actuation mechanisms from damage.

In some aspects, the method for controlling descent during a control tier failure may be implemented from various entry conditions. The initial state of the UAV when the control tier failure is detected and the deep stall maneuver is initiated may significantly influence the execution and effectiveness of the maneuver. The UAV may enter the deep stall maneuver from different flight modes. In some implementations, the maneuver may be initiated while the UAV is in a hover mode, with little to no forward velocity. In other cases, the UAV may be in forward flight mode when the control tier failure occurs. The transition from these different flight modes into the deep stall may require varying approaches to control surface deflection and timing. The altitude at which the control tier failure is detected may also impact the implementation of the stall maneuver. At higher altitudes, the UAV may have more time to fully develop the deep stall before approaching the ground. This may allow for a more gradual transition into the stall configuration. At lower altitudes, a more rapid transition may be necessary to achieve the desired descent characteristics before ground impact.

The speed of the UAV at the time of failure detection may influence the execution of the stall maneuver. In some aspects, if the UAV is traveling at high speed when the failure occurs, the initial deflection of the control surfaces may need to be more aggressive to quickly reduce forward velocity and induce the stall. Conversely, at lower speeds, a more gradual deflection may be sufficient to initiate the stall. The orientation of the UAV when the failure is detected may also affect the implementation of the stall maneuver. In some cases, the UAV may be in a level attitude, while in others it may be climbing, descending, or banked. The method for transitioning into the deep stall may need to account for these different initial orientations to ensure a stable entry into the maneuver.

Environmental conditions at the time of failure may also impact the execution of the stall maneuver. Wind speed and direction, air density, and temperature may all influence the UAV's behavior as it enters the deep stall. The method for implementing the maneuver may need to adapt to these varying conditions to maintain consistent performance. In some implementations, the computing device may use sensor data to determine the UAV's current state and environmental conditions at the time of failure detection. This information may be used to adjust the timing and rate of control surface deflection to optimize the entry into the deep stall maneuver for the specific circumstances. The method for implementing the stall maneuver may also consider the UAV's current mission phase. For example, the approach may differ if the failure occurs during takeoff, mid-flight, or while preparing for landing. Each of these phases may present unique challenges and priorities for the execution of the maneuver.

In some aspects, the stall maneuver may be implemented by adjusting multiple parameters in addition to deflecting the control surfaces. The computing device may coordinate changes in throttle settings and aircraft pitch to enhance the effectiveness of the deep stall maneuver. The throttle of the UAV's propulsion system may be adjusted in conjunction with the control surface deflection. In some implementations, the computing device may reduce throttle to idle or cut power entirely to the main propulsion system upon detecting a control tier failure. This reduction in thrust may help the UAV transition more quickly into the stall condition. In other cases, the throttle may be modulated during the descent to fine-tune the UAV's sink rate and forward velocity. The pitch attitude of the UAV may also be actively managed during the stall maneuver. In some aspects, the computing device may command a nose-up pitch attitude immediately before or concurrent with the ruddervator deflection. This pitch-up command may be achieved through a combination of control surface movements and thrust vectoring, if available. The increased angle of attack resulting from the pitch-up maneuver may facilitate a more rapid entry into the deep stall condition.

The timing and sequencing of these adjustments may vary depending on the UAV's initial flight conditions and the severity of the control tier failure. In some implementations, the computing device may execute a pre-programmed sequence of throttle, pitch, and control surface adjustments. In other cases, the device may dynamically adjust these parameters based on real-time sensor feedback during the maneuver.

The magnitude of throttle and pitch adjustments may be scaled based on factors such as the UAV's current speed, altitude, and weight. For example, at higher speeds, a more aggressive reduction in throttle and a larger pitch-up command may be used to rapidly bleed off energy and induce the stall. At lower speeds or altitudes, more subtle adjustments may be sufficient to achieve the desired stall characteristics.

In some aspects, the computing device may use different strategies for implementing the stall maneuver based on the nature of the control tier failure. For instance, if certain control surfaces remain partially functional, the device may utilize a combination of control surface deflection and differential throttle control to induce and maintain the deep stall condition. The method of implementing the stall maneuver through coordinated adjustments of control surfaces, throttle, and pitch may provide greater flexibility in managing the UAV's descent profile. This multi-faceted approach may allow for more precise control over the aircraft's behavior during the contingency maneuver, potentially improving its effectiveness across a wider range of failure scenarios and flight conditions.

In some aspects, a non-transitory computer-readable medium may have stored thereon instructions that, when executed by a computing device, cause the computing device to perform operations for controlling the descent of a UAV during a control tier failure. These instructions may be part of a software program or firmware that governs the UAV's behavior in various flight conditions. The stored instructions may include routines for detecting a control tier failure at the UAV. This detection process may involve analyzing data from multiple sensors, comparing current flight parameters to expected values, and identifying anomalies that could indicate a failure in the control systems. Upon detecting a control tier failure, the instructions may direct the computing device to adjust the control surfaces of the stabilizers from a first angle to a second angle relative to the fixed portions of the stabilizers. The specific angles and rate of adjustment may be determined based on various factors such as the UAV's current speed, altitude, and weight.

In some implementations, the instructions may include algorithms for dynamically calculating the optimal second angle based on real-time flight conditions. These algorithms may take into account factors such as wind speed and direction, air density, and the UAV's current attitude to determine the most effective control surface position for inducing and maintaining a stable deep stall.

The stored instructions may also include routines for managing other aspects of the UAV's systems during the descent. For example, the instructions may direct the computing device to adjust throttle settings, manage power distribution, or control the windmilling of hover rotors to further optimize the descent characteristics. In some aspects, the instructions may include contingency plans for various types of control tier failures. These plans may specify different sequences of actions or control surface adjustments based on the nature and severity of the detected failure.

The non-transitory computer-readable medium may also store instructions for logging flight data during the descent maneuver. This data may be used for post-flight analysis, system improvements, or regulatory compliance purposes. In certain implementations, the stored instructions may allow for updates or modifications to the descent control algorithms. This flexibility may enable the UAV's behavior to be refined based on real-world performance data or changes in operational requirements.

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

1. An uncrewed aerial vehicle (UAV) comprising:
a fuselage;
a pair of wings extending outwardly from the fuselage;
a pair of stabilizers arranged in a V-shape configuration, wherein each stabilizer has a control surface that is adjustable relative to a fixed portion of the stabilizer; and
a computing device configured to:
detect a control tier failure at the UAV; and
based on detecting the control tier failure at the UAV, adjust the control surface of each stabilizer from a first angle to a second angle relative to the fixed portion of the stabilizer.

2. The UAV of claim 1, wherein the pair of stabilizers that are arranged in the V-shape configuration form a V-tail of the UAV, and wherein each stabilizer extends in a vertical diagonal direction away from a longitudinal axis of the fuselage.

3. The UAV of claim 1, wherein when positioned at the first angle, the control surface of each stabilizer is aligned substantially flat along the fixed portion of the stabilizer, and wherein each control surface is positioned at the first angle during forward travel by the UAV.

4. The UAV of claim 3, wherein when positioned at the second angle, the control surface of each stabilizer is substantially perpendicular to the fixed portion of the stabilizer.

5. The UAV of claim 1, further comprising:
a first boom coupled to a first wing of the pair of wings, wherein the first boom extends in a direction substantially parallel to the fuselage of the UAV and perpendicular to the first wing; and
a second boom coupled to a second wing of the pair of wings, wherein the second boom extends in the direction substantially parallel to the fuselage of the UAV and perpendicular to the second wing.

6. The UAV of claim 5, wherein a first stabilizer of the pair of stabilizers is coupled to an end of the first boom that is positioned relative to a rear of the fuselage and a second stabilizer of the pair of stabilizers is coupled to an end of the second boom that is positioned relative to the rear of the fuselage, and
wherein the first stabilizer and the second stabilizer are physically separate.

7. The UAV of claim 6, further comprising:
a first plurality of hover rotors coupled to the first boom and a second plurality of hover rotors coupled to the second boom,
wherein the computing device is configured to trigger the first plurality of hover rotors and the second plurality of hover rotors to freely rotate in response to detecting the control tier failure at the UAV.

8. The UAV of claim 1, wherein the computing device is further configured to:
determine a speed and an altitude of the UAV; and
select the second angle based on the speed and the altitude of the UAV.

9. The UAV of claim 1, further comprising:
a sensor coupled to the UAV, wherein the computing device is configured to detect the control tier failure of the UAV based on sensor data provided by the sensor.

10. The UAV of claim 1, wherein the computing device is configured to determine the second angle based on an altitude, a speed, and a weight of the UAV.

11. The UAV of claim 10, wherein the computing device is further configured to determine the second angle based on wind conditions of an environment of the UAV.

12. The UAV of claim 1, wherein each control surface is adjustable across a range of angles comprising the first angle and the second angle.

13. A method for controlling a descent of an uncrewed aerial vehicle (UAV) during a control tier failure comprising:
detecting, by a computing device, the control tier failure at the UAV,
wherein the UAV includes a fuselage, a pair of wings extending outwardly from the fuselage, and a pair of stabilizers arranged in a V-shape configuration, and
wherein each stabilizer has a control surface that is adjustable relative to a fixed portion of the stabilizer; and
based on detecting the control tier failure at the UAV, adjusting the control surface of each stabilizer from a first angle to a second angle relative to the fixed portion of the stabilizer.

14. The method of claim 13, wherein the pair of stabilizers that are arranged in the V-shape configuration form a V-tail of the UAV, and wherein each stabilizer extends in an vertical diagonal direction away from a longitudinal axis of the fuselage.

15. The method of claim 14, wherein when positioned at the first angle, the control surface of each stabilizer is aligned substantially flat along the fixed portion of the stabilizer,
wherein each control surface is positioned at the first angle during forward travel by the UAV, and
wherein when positioned at the second angle, the control surface of each stabilizer is substantially perpendicular to the fixed portion of the stabilizer.

16. The method of claim 13, wherein the UAV further comprises:
a first boom coupled to a first wing of the pair of wings, wherein the first boom extends in a direction substantially parallel to the fuselage of the UAV and perpendicular to the first wing; and
a second boom coupled to a second wing of the pair of wings, wherein second boom extends in the direction substantially parallel to the fuselage of the UAV and perpendicular to the second wing,
wherein a first stabilizer of the pair of stabilizers is coupled to an end of the first boom that is positioned relative to a rear of the fuselage and a second stabilizer of the pair of stabilizers is coupled to an end of the second boom that is positioned relative to the rear of the fuselage, and
wherein the first stabilizer and the second stabilizer are physically separate.

17. The method of claim 16, wherein adjusting the control surface of each stabilizer from the first angle to the second angle relative to the fixed portion of the stabilizer comprises:
adjusting the control surface of the first stabilizer from the first angle to the second angle relative to the fixed portion of the first stabilizer; and
adjusting the control surface of the second stabilizer from the first angle to a third angle relative to the fixed portion of the second stabilizer, wherein the third angle differs from the second angle.

18. The method of claim 16, further comprising:
triggering, based on detecting the control tier failure at the UAV, a plurality of hover rotors to freely rotate, wherein each hover rotor is coupled to either the first boom or the second boom.

19. The method of claim 13, further comprising:
determining a speed, an altitude, and a weight of the UAV; and
selecting the second angle based on the speed, the altitude, and the weight of the UAV.

20. A non-transitory computer-readable medium may have stored thereon instructions that, when executed by a computing device, cause the computing device to perform operations comprises:
detecting a control tier failure at an uncrewed aerial vehicle (UAV),
wherein the UAV includes a fuselage, a pair of wings extending outwardly from the fuselage, and a pair of stabilizers arranged in a V-shape configuration, and
wherein each stabilizer has a control surface that is adjustable relative to a fixed portion of the stabilizer; and
based on detecting the control tier failure at the UAV, adjusting the control surface of each stabilizer from a first angle to a second angle relative to the fixed portion of the stabilizer.
